(19) United States
(12) Patent Application Publication
(10) Pub. No.: US 2010/0060042 A1
(43) Pub. Date: Mar. 11, 2010

(54) HEADLINER ASSEMBLY METHOD AND APPARATUS

(76) Inventors: Jamie C. Budek, Holland, MI (US); Paul E. Cole, Canadian Lakes, MI (US); Mark William Essenburg, Zeeland, MI (US); Todd Alvin Hoogland, Zeeland, MI (US); Michael Joseph Cook, Cedar Springs, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/207,918

(22) Filed: Sep. 10, 2008

(51) Int. Cl. B62D 25/06; B23P 11/02

(52) U.S. Cl. 296/214; 29/453

(57) ABSTRACT

An apparatus for making differently configured vehicle headliner/overhead systems as desired includes a plurality of stations for assembly operations in which components are attached to a preshaped headliner/overhead system core, parts nests for the components, presses for holding the headliner/overhead system core between a loaded parts nest and the presses, sensors for determining that the appropriate components have been loaded in the parts nests and that the core has been correctly positioned at an assembly station, an applicator for attaching the components to the core, a reader for reading indicia from the core indicating required assembly operations for the core, and a controller for effecting the appropriate assembly operations conforming with the information read by the reader.

### FIELD OF THE INVENTION

The present invention relates to the field of manufacturing vehicle headliners and overhead systems.

### BACKGROUND OF THE INVENTION

A headliner that performs a variety of different functions, including sound absorption/attenuation and a thermal insulative function, is typically installed on the interior side of the roof of a vehicle cabin. Vehicle headliners generally comprise a core having a plurality of layers (e.g., fibrous layer, foam layer, fabric layer) that are shaped to conform approximately to the contours of a vehicle cabin roof. Additionally, the headliner is used as a substrate for holding various components adjacent the vehicle roof, such as overhead consoles, visors, coat hooks, dome/map lamps, etc, referred to as the overhead system. Often, a vehicle model will have several different trim options that may require differently shaped or sized headliners having different components attached thereto.

### SUMMARY OF THE INVENTION

An apparatus and related method for assembling a variety of different types of vehicle headliner/overhead systems without having to manually change tooling. It includes in one embodiment a controller and related sensors and indicators for both directing and monitoring the assembly operation, and preferably also for confirming proper assembly in a final quality check.

In another aspect of the invention, conveyor supports and presses moveable relative to one another facilitate ease of handling of a headliner core during assembly, as do pivotally mounted loading supports and assembly supports.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view showing an apparatus in accordance with the invention for manufacturing a vehicle headliner/overhead system.

FIG. 2 is a perspective view of a loading apparatus for loading a headliner core onto a first station of the manufacturing apparatus.

FIGS. 3 and 4 are perspective views showing the loading apparatus of FIG. 2 holding a headliner core in vertical and horizontal orientations respectively.

FIG. 5 is a top plan view of an assembly station of the apparatus.

FIG. 6 is a perspective view of the assembly station shown in FIG. 5.

FIG. 7 is a front elevational view of the assembly station shown in FIGS. 5 and 6.

FIGS. 8 and 9 show an assembly station having a two-stage press in which presses are individually moveable with respect to a press carrier that is moveable.

FIG. 10 is a perspective view of a conveyor used at one or more of the assembly stations, in its lowered position.

FIG. 10A is a perspective view of the conveyor of FIG. 10, shown in its elevated condition.

FIG. 10B shows a conveyor (and associated assembly station components) adapted for use at a station at which a moon roof retainer ring is installed onto the headliner core showing, a support rod in its extended position.

FIG. 10C shows an enlarged fragmentary perspective view of the intermediate conveyor rail and extended support rod of the conveyor of FIG. 10B.

FIG. 10D shows the view of FIG. 10C with the support rod retracted, in order to allow installation of the moon roof retainer ring.

FIG. 10E is a perspective review of yet another type of conveyor for use at an assembly station spaced a short distance from the next station, such that the conveyor extends into the gap between the two stations when the headliner core is to be conveyed to the next station.

FIG. 11 is a perspective view of an assembly station (in part) with an associated headliner invertor used for conveying a headliner from one station to the next by flipping it into an inverted position.

FIGS. 11A and 11B show details of clamps used in the invertor shown in FIG. 11.

FIG. 11C shows the invertor of FIG. 11 holding a partially assembled headliner in a vertical orientation.

FIG. 12 shows an assembly station having a support structure that is tippable to allow enhanced human or robotic operator access to a headliner supported thereon.

FIG. 12A is a front elevational view of the assembly station shown in FIG. 12.

FIG. 12B shows the tiltable assembly station of FIG. 12, with a headliner core in position on the tilt table.

FIG. 13 shows a perspective view of a dome/map lamp retainer parts nest assembly, with the retainer exploded away from the nest.

FIG. 13A shows a side elevational view of a dome/map lamp retainer parts nest assembly.

FIGS. 14 and 14A show, in different positions of operation, a parts nest assembly for installing a dome/map lamp into a retainer mounted in a headliner.

FIG. 15 is a perspective view of a parts nest for a safety countermeasure, with the countermeasure shown exploded away from the parts nest.

FIG. 16 shows a parts nest that is used for attaching a magnet and a plastic carrier combination to a headliner core.

FIG. 17 is a parts nest assembly for receiving a coat hook attachment clip, and for facilitating attachment of a coat hook thereto, with the coat hook and attachment clip exploded away.

FIG. 17A is an enlarged view of the encircled area 17A of FIG. 17.

FIG. 18 is a perspective view of a screw driver having a sensor for detecting proper torque, time and revolutions in a fastening operation.

FIG. 19 is a perspective view of an assembly fixture used for closing a hinged cover on a coat hook affixed to a headliner core.

FIGS. 20 and 20A show a parts nest with a slide lock part retainer.

FIG. 21 is a perspective view and partial schematic of an apparatus for powering and switching a switch on a dome/map lamp attached to a headliner core for testing.

FIG. 22 is a schematic diagram of a process.

### DETAILED DESCRIPTION OF PREFERRED EMBODIMENTS

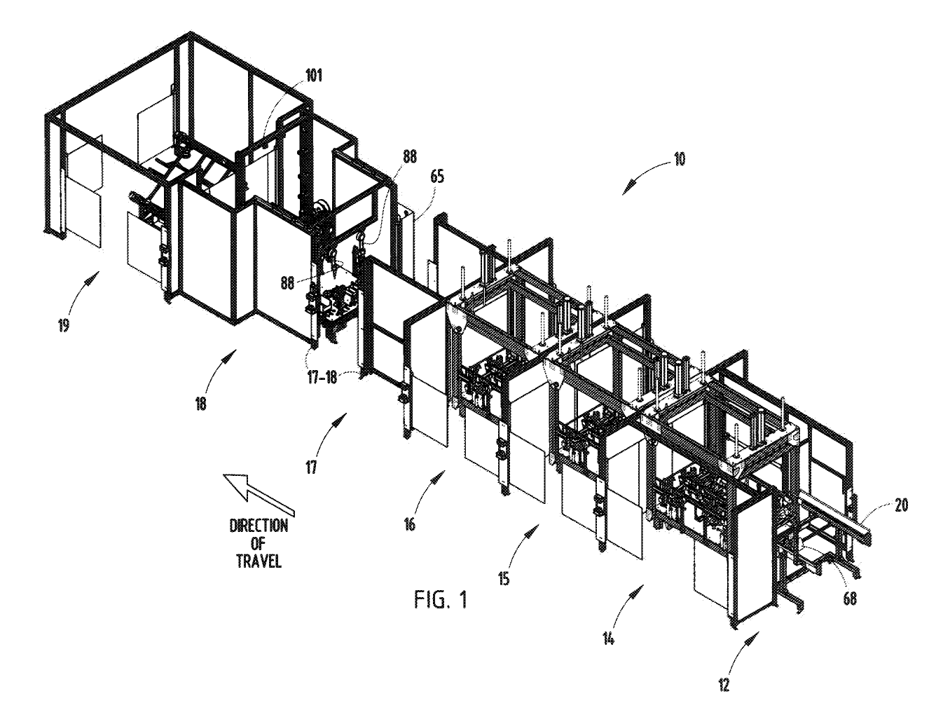

Shown in FIG. 1 is a perspective view of an apparatus 10 for assembling a vehicle headliner/overhead system. The apparatus includes a loading station 12 and a plurality of stations 14, 15, 16, 17 18 and 19. Various vehicle headliner/overhead system assembly components, such as dome/map lamps, visors, overhead consoles, wire harnesses, coat hooks, magnets, “cowboy hat” spacers and energy absorption counter-measures are affixed to the vehicle headliner assembly at the various stations. Headliner cores are loaded at loading station 12, and are moved from station to station in the direction indicated by the direction of travel arrow in FIG. 1. Direction of travel arrows are also provided in other figures to show the direction of travel of headliner cores as they move to and through the apparatus shown in the figures.

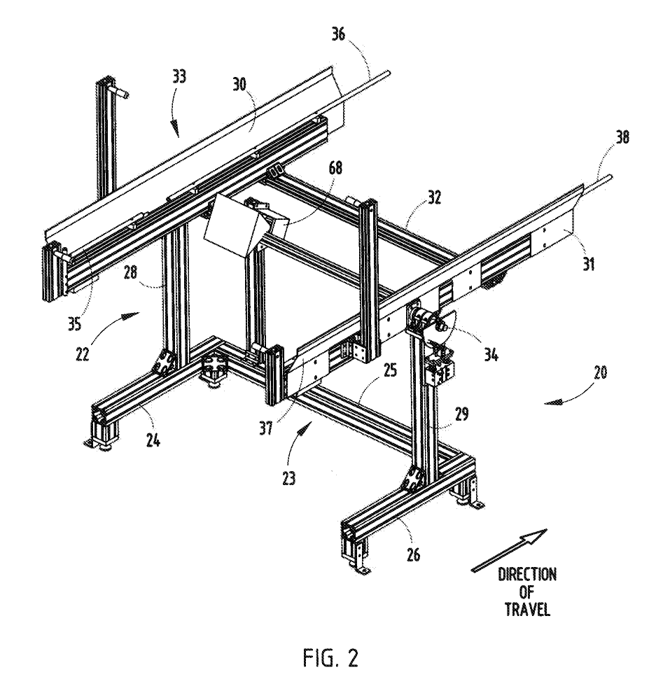

Loading station 12 includes a load support structure 20, which is shown in greater detail in FIG. 2. Load support structure 20 includes a frame 22 that includes a base 23 having horizontal members 24, 25 and 26, and upright members 28 and 29 pivotably supporting headliner core edge supports 30 and 31. A cross member 32 connects headliner core edge supports 30 and 31 together so that they are rotatable together around axles 33 and 34 with respect to the frame 22. Headliner core edge supports 30 and 31 have ledges 35, 36, 37 and 38 that define support surfaces upon which the edges of a headliner core may be placed. Load support structure 20 includes an optical scanner 68 or reader that reads indicia (e.g., a bar code printed on the headliner core or on a sticker adhesively attached to headliner core) on a headliner core being supported on the load support structure. Bar code readers and similar devices for acquiring information from a label, tag or the like affixed to an item are well known and therefore are not described in detail herein.

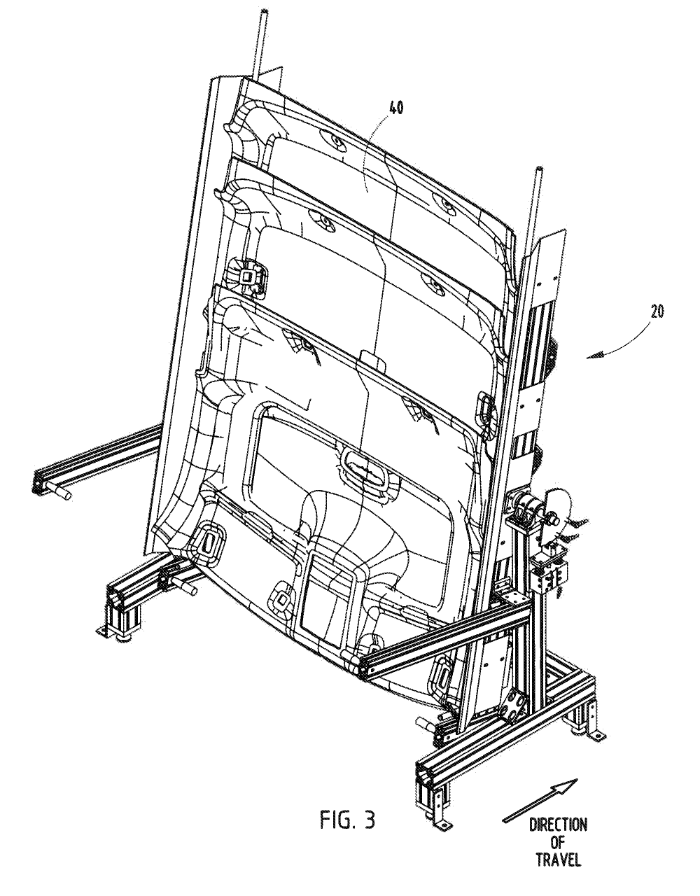

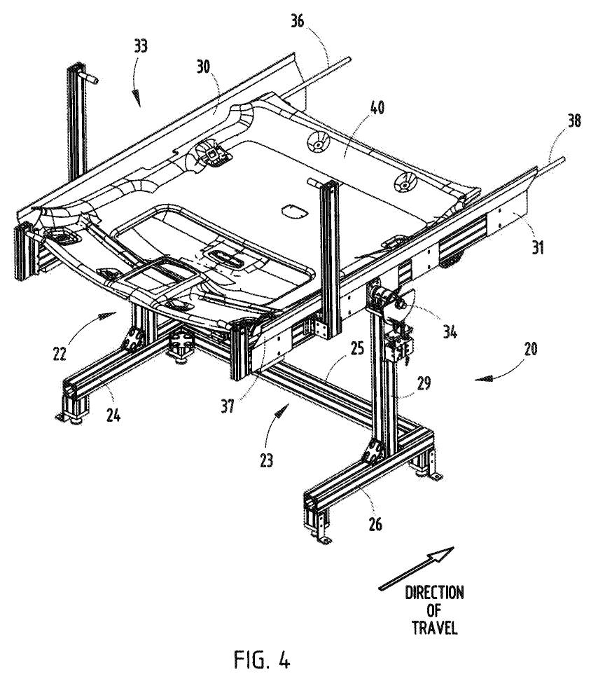

As shown in FIG. 3 load support structure 20 is configured to receive and hold a preformed three-dimensionally configured headliner core 40. As can be seen by comparing FIGS. 3 and 4, headliner core 40 and edge supports 30, 31 may be rotated between vertical and horizontal positions to facilitate loading of a headliner core on apparatus 10. Headliner core 40 are most easily handled in their vertical orientation. Thus, supports 30, 31 are moveable into the vertical position shown in FIG. 3 for receiving a headliner core 40, and are then rotated into the horizontal position shown in FIG. 4 for transferring core 40 into assembly station 14.

Each of the stations 14, 15, 16, 17, 18 and 19 includes core support features (e.g., locating/indexing elements) for properly locating the headliner core with respect to assembly equipment. Also associated with one or more of the assembly stations 14, 15, 16, 17, 18 and 19 is at least one parts nest, for example items 42, 43 and 44, that is configured to hold and position a headliner component adjacent the preformed headliner core 40.

The present apparatus affords great flexibility in designing different functions into each of the various assembly stations 14-19. In one embodiment, the following functions are built into stations 14-19:
Station 1 (14): Parts nests are provided for overhead consoles and retainers therefore, lamp retainers, wire keepers and safety counter measures. Attachment equipment, preferably infrared heaters, are provided for attaching, e.g., heat welding, the wire keepers and safety counter measures to the core.
Station 2 (15): Parts nests and infrared heaters are provided for additional safety counter measures and wire clips; parts nests for lamps to be installed to lamp retainers are provided; magnets mounted in plastic carriers are heat welded in place; and foams having pressure sensitive adhesive layers are pressed into place on the cores.
Station 3 (16): More parts nests for additional safety measures and wire hold downs are provided; parts nests and infrared heaters are provided for heat welding additional plastic carriers containing magnets in place; a parts nests for a moon roof ring to be attached to the core is provided; and coat hooks are attached to the core.
Station 4 (17): In this embodiment, station 4 is an accumulator station.
Station 5 (18): Parts nests are provided for “cowboy hat” brackets for attaching to the core in order to facilitate attachment to the roof of the vehicle; visor receptacles are attached; visors are attached to the cowboy hat brackets by being screwed in place; station 5 also has an inverter which serves as a second accumulator station; and
Station 6 (19): Wire harnesses and pieces of foam for spacing, wire retaining and/or noise reduction are attached.

Of course the functions to be accomplished at each station can be varied and additional stations or fewer stations can be employed. The system of the present invention is designed so that the particular functions carried out at each station can be varied without resetting the machine, simply as a function of the style of headliner which is to be made, as indicated by the barcode on the core.

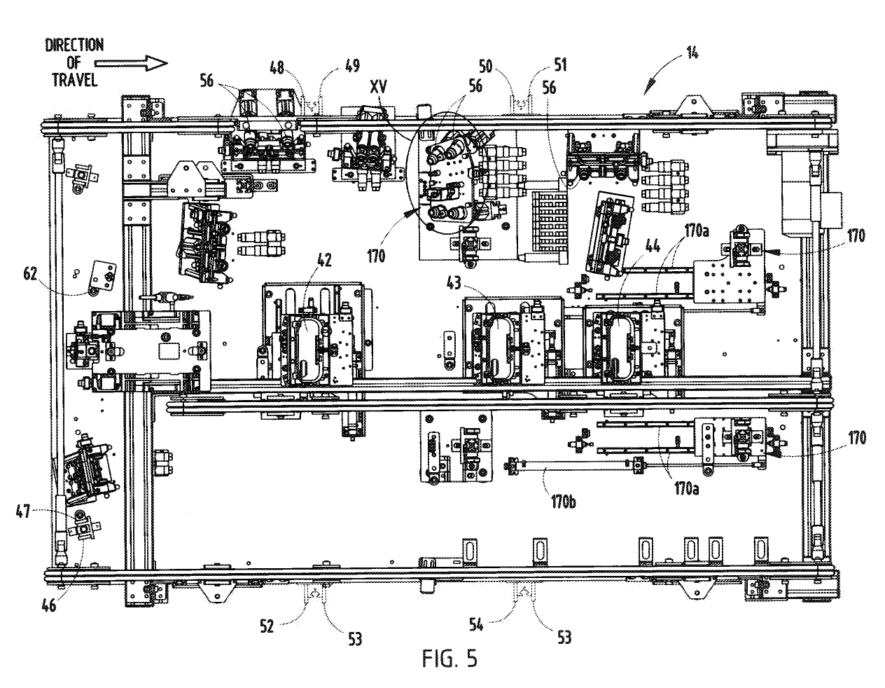

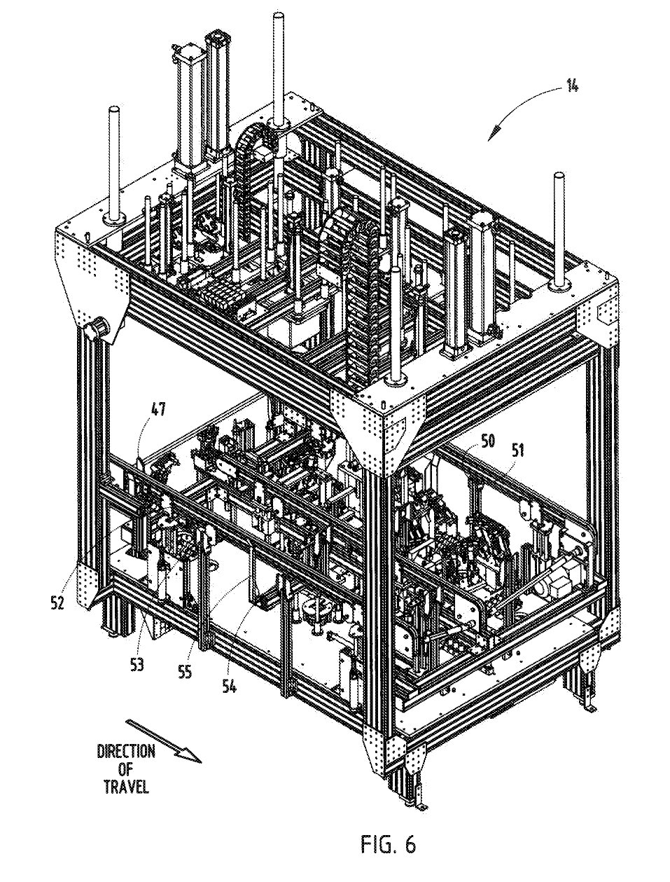

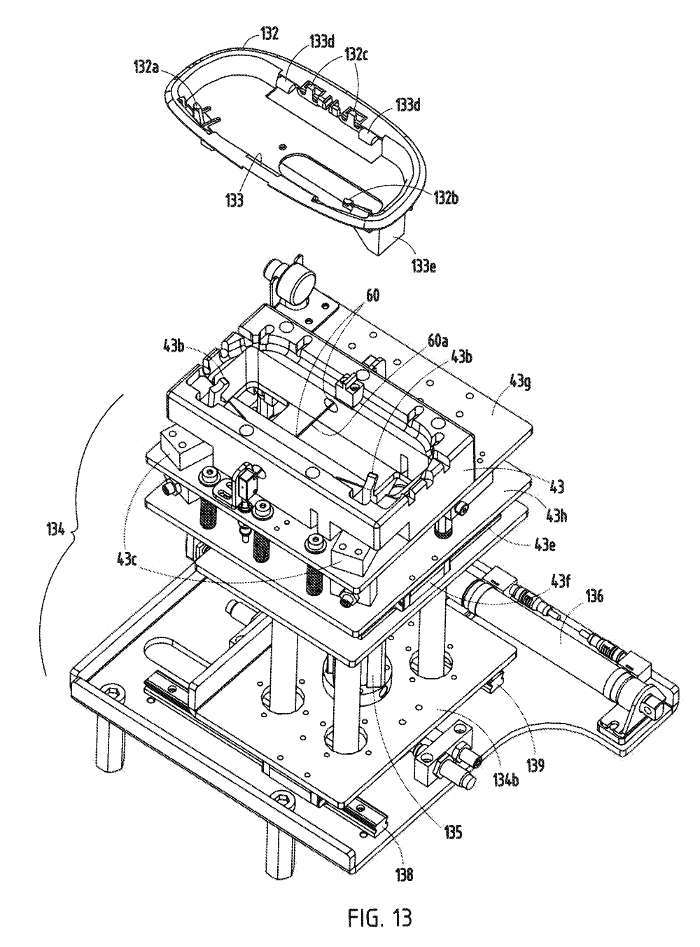

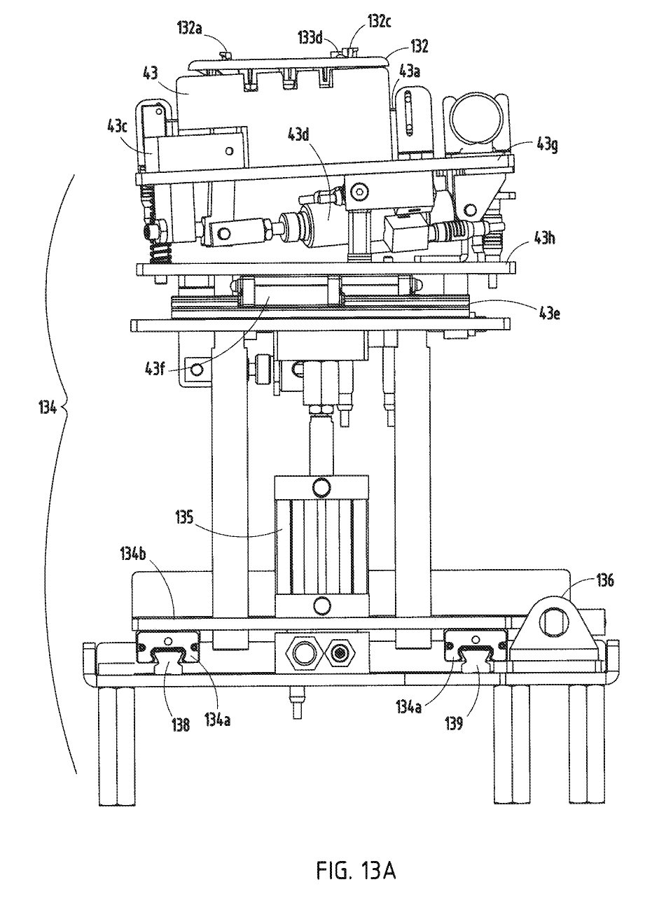

FIG. 5 shows a first assembly station 14 having a plurality of parts nests 42, 43 and 44 for receiving interior dome/map lamp retainers 132 (see FIG. 13) that are to be attached to a headliner. The nests 42, 43 and 44 are configured to hold and position a headliner component adjacent core 40. Parts nests for other components may be provided at assembly station 14 and/or at one of the other assembly stations. While it is conceivable that a plurality of dome/map lamp retainer parts nests could be used to facilitate attachment of a plurality of dome/map lamps to a single headliner core 40, such arrangement may also be used to attach a single dome/map lamp retainer 132 at any of a plurality of different positions on a headliner, or different parts nests may be used for attaching one or more dome/map lamps to any of a variety of different positions, of different sized or different styled headliners. Similarly, parts nests for other components, such as safety countermeasure parts nest 170, are provided at this work station to facilitate attachment of various other components as desired or needed for a particular headliner assembly.

FIG. 6 is a perspective view of the first assembly station 14, which shows core support structures or features for properly locating or indexing a preformed three-dimensionally configured headliner core 40 with the various parts nests, such as parts nests 42, 43 and 44, to facilitate attachment of components, such as a dome/map lamp retainer, to core 40 at a precisely predetermined location. Such features are shown in FIGS. 5 and 6, and include locators and/or guides 46, 47, 48 49, 50, 51, 52, 53, 54 and 55 that either project through locator holes provided in a core 40 or engage edges of core 40 to hold or guide core 40 into a proper portion for attachment of parts held in nests, such as nests 42, 43 and 44.

Associated with at least certain of the parts nests are applicators 56 (FIG. 5) for facilitating adherence of a headliner component to core 40. While infrared heat applicators are illustrated and have certain advantages, other types of applicators, including glue applicators, rivets, etc., may be employed. Infrared heat applicators are believed to be particularly advantageous because they are capable of heating selected surfaces of a plastic component to the melt temperature of the plastic to facilitate adhesion of the component to the core, without significantly heating surfaces that are immediately adjacent to the bonding surfaces. This substantially reduces the risk of damage to headliner components and assembly apparatus, and significantly reduces the risk of injury and/or discomfort to assembly workers. It also provides cost savings and weight reduction in the final part, due to the elimination of glue.

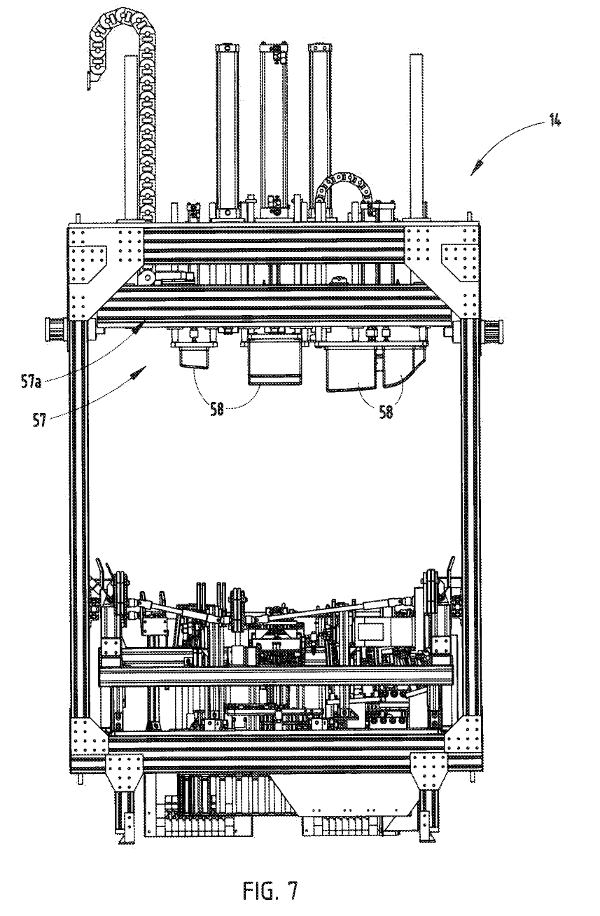

The assembly stations usually include a press assembly 57 (FIG. 7). Press assembly 57 includes an upper platen, or moveable frame 57a, upon which are mounted a plurality of individual presses 58 or upper platen parts nests. In operation, upper platen 57a descends a portion of the way towards a core member positioned in the assembly station, and then appropriate individual presses 58 or upper platen parts nests, descend the rest of the way into engagement with the core, to press the core against a part located in a parts nest on the other side of the core. Whether a particular press 58 is activated is a function of the parts which are required for the particular model headliner for which the core is being used.

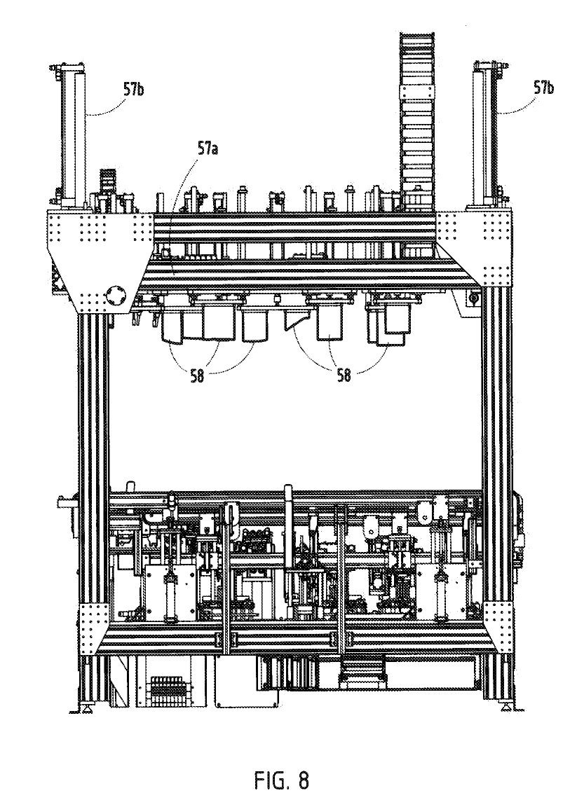

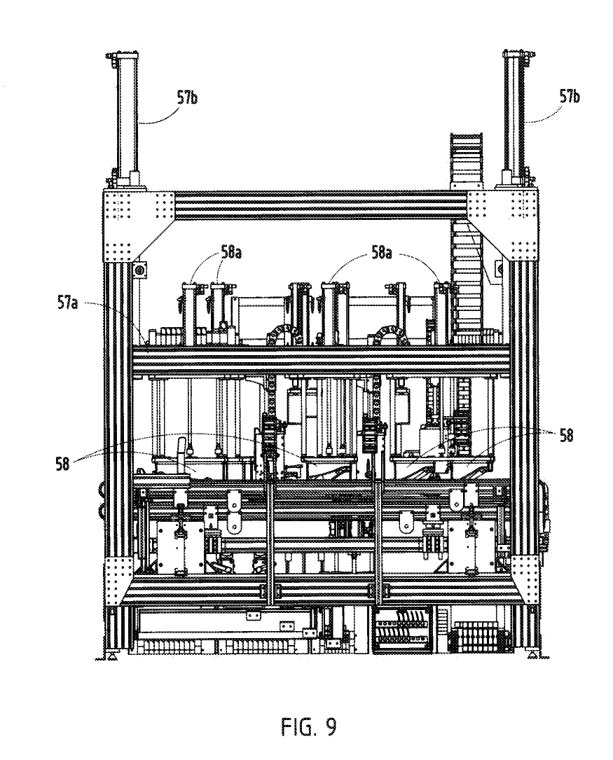

This two-stage movement of press assembly 57 is illustrated in FIGS. 8 and 9. In FIG. 8, upper platen 57a is in its upper position, as are individual presses 58. In FIG. 9, upper platen 57 has been extended downwardly by cylinders 57b, and then the various presses 58 have been extended down still further by their hydraulic or pneumatic cylinders 58a.

In the FIGS. 7-9 illustrated embodiments, press upper platen 57a and presses 58 are reciprocally moveable with respect to the parts nests, upwardly and downwardly, to allow the core and a component being attached to the core to be pressed between press 58 and a parts nest. However, as an alternative, or in conjunction with movement of the press platen 57a and presses 58, the core support structures, including the parts nests, may be reciprocally moveable to compress the core and components between the press and parts nests during attachment of the parts to the core.

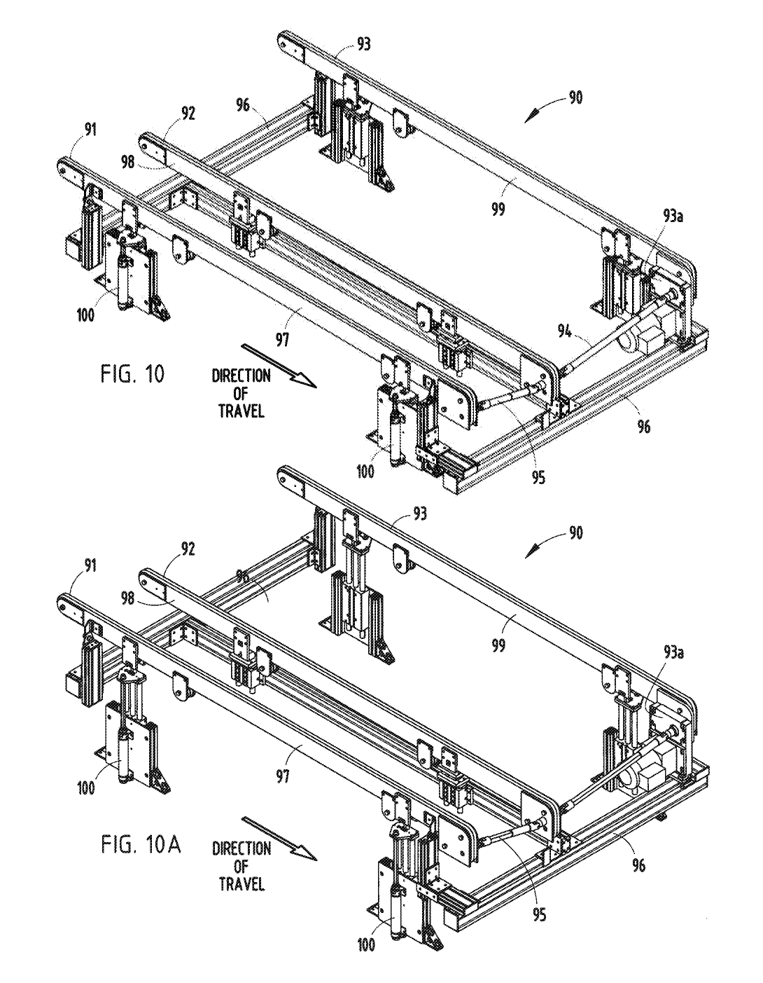

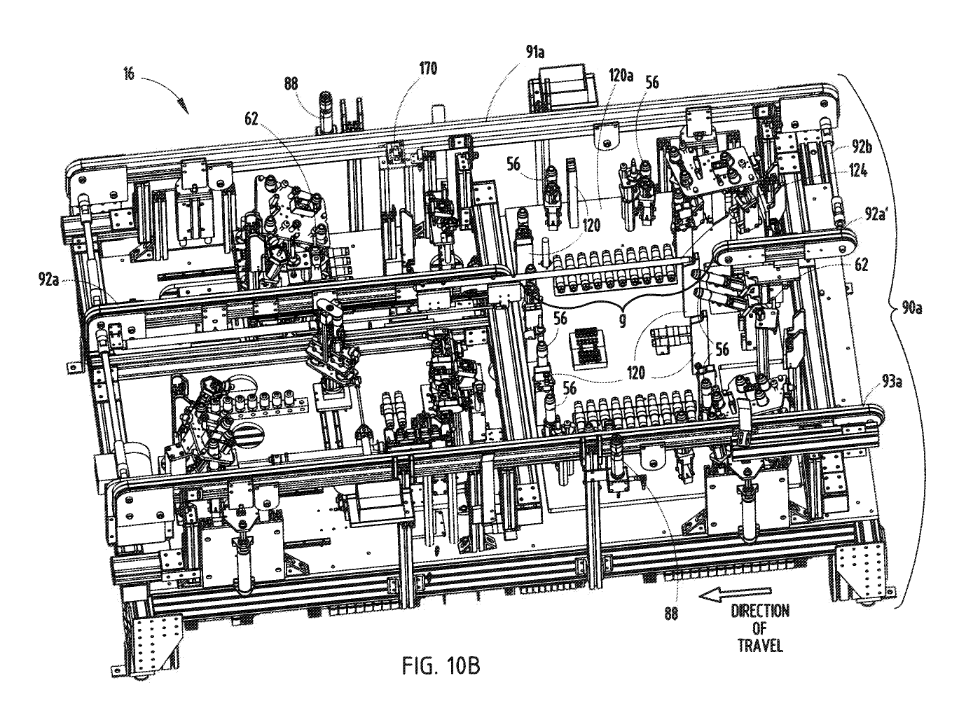

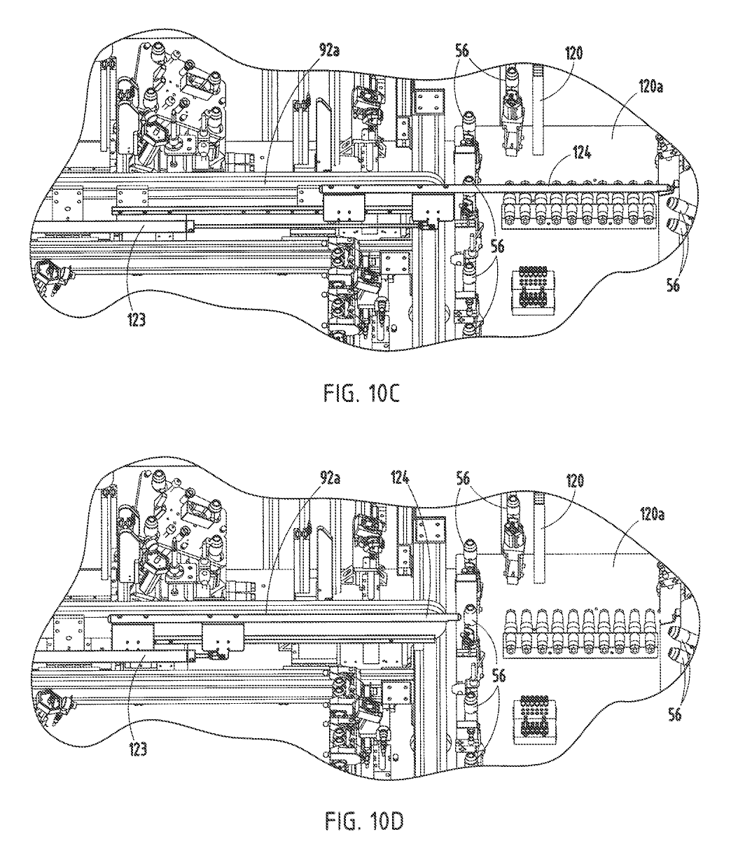

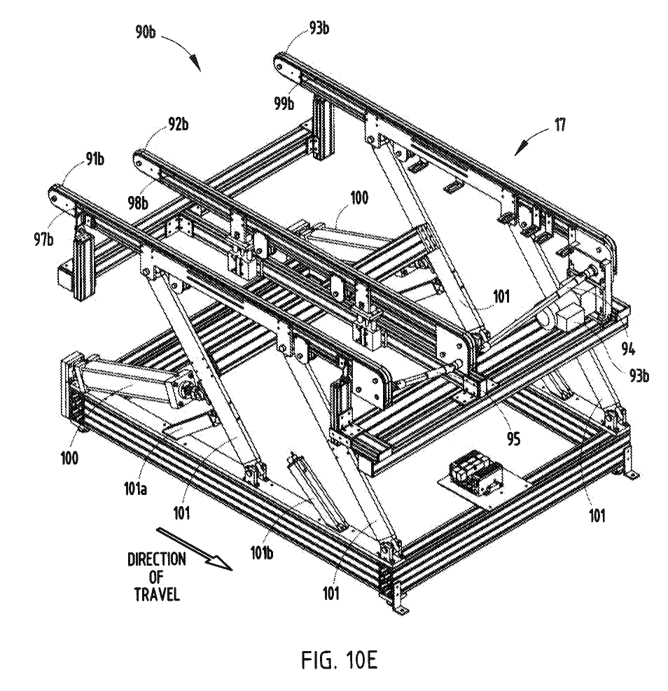

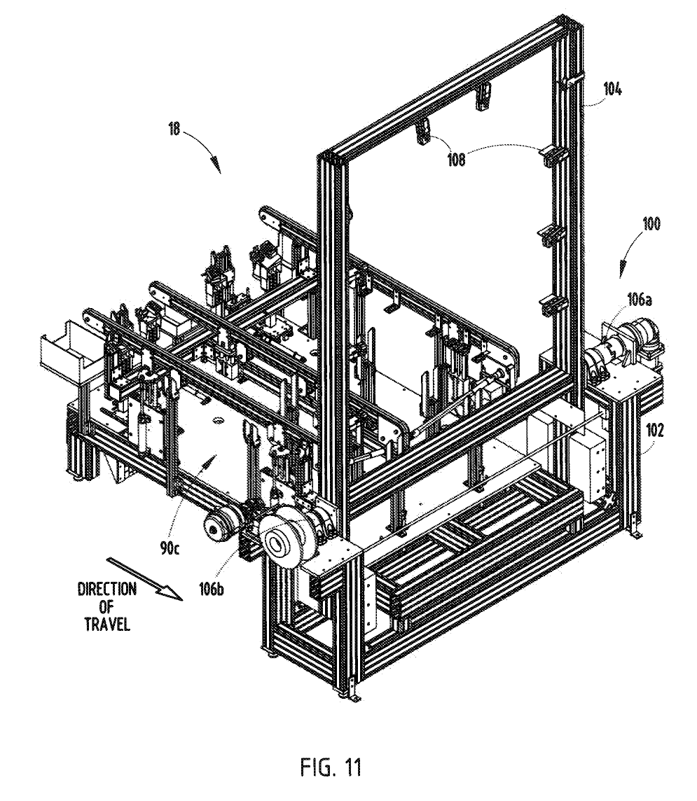

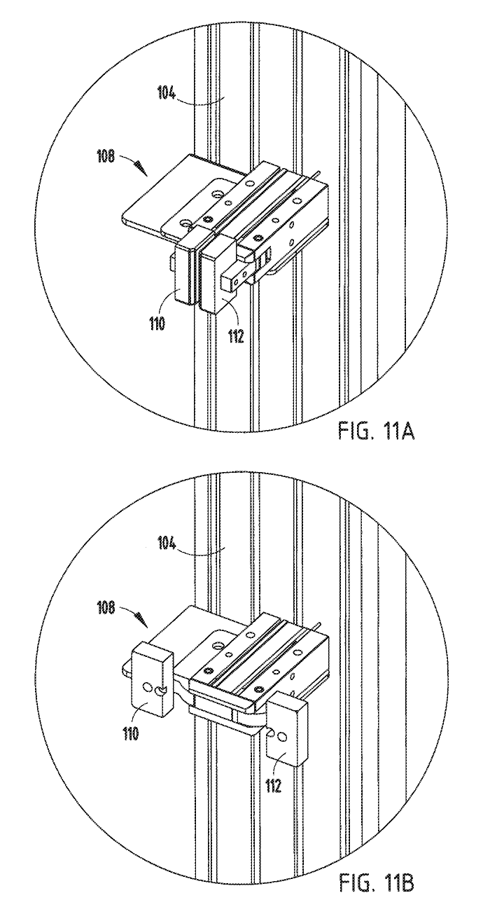

The parts nests preferably include sensors 60 to sense whether or not a headliner component is properly positioned in the parts nests. Sensors 60 may be single pressure or contact sensor, an optical beam sensor, an optical proximity sensor, a vacuum sensor (used in conjunction with a parts holding vacuum cup), or any other suitable sensor that is capable of being used to determine the presence or absence of a required component, and/or the proper positioning of the component in the parts nests. Similarly, sensors 62 (FIGS. 5 and 10B) may be employed to verify or determine whether the core 40 is properly positioned on the core support structure. Preferably, sensor 62 detects the distance from the sensor to the core, and reports the measured distance to a controller, which compares the measured distance to an appropriate distance that is known from the information obtained by reader 68.

Apparatus 10 includes one or more conveyors 90 positioned at one or more stations for moving headliner core 40 from one station to the next (FIG. 10). Typically, conveyor 90 includes three conveyor belts 91, 92 and 93 that support the edges and intermediate area of a headliner core 40. Motor and gear box 93a drives belt 93, which in turn is linked to belts 92 and 93 by linkages 94 and 95 to ensure that the belts move together at the same rate. Belts 91, 92 and 93 rotate around belt support rails 97, 98 and 99, which are joined by frame cross pieces 96 so as to be moveable together upwardly and downwardly by four hydraulic or pneumatically operated cylinders 100, one located generally at each corner of the assembly. During horizontal transport of the core, belts 91, 92 and 93 are located above the level of the core support structure. During assembly operations, belts 91, 92 and 93 are located below the core support structure so that they do not interfere with assembly operations. FIG. 10 shows conveyor 90 in its lowered position, and FIG. 10A shows it in its elevated position. Alternatively, conveyor system 90 may be vertically immoveable, and the core support structure may be vertically moveable to raise the core above the belts during assembly operations, and to lower the core back onto the belts after assembly operations have been completed. Desirably, conveyor system 90 accommodates different headliners having slightly different shapes or depths by providing adjustability of the height of side belts 91 and 93 relative to center belt 92.

A special conveyor 90a is provided at station 3 (16) to facilitate handling of a core having a moon roof opening in it (FIG. 10B). As illustrated in FIG. 10B, station 3 (16) includes a parts nest comprising a plurality of supports 120 for holding a backer ring for a moon roof opening. A conveyor 90a for receiving and moving a headliner core from a preceding station and into a proper position for assembly operations at station 3 and subsequently moving the core to a succeeding station after assembly operations at station 3 have been completed, includes edge conveyor belts 91a and 93a, and an intermediate belts 92a and 92a′ located between the edge belts. Intermediate belts 92a and 92a′ are aligned and spaced apart to define a gap g. Belt 92a′ is driven by linkage 92b to belt 91a. Gap g has a dimension that is greater than the width of the moon roof opening so that a moon roof backer ring held on supports 120 can be moved up into engagement with the core (or the core lowered into engagement with the backer ring) without interference from the centrally located belts 92a and 92a′ of the conveyor system. A moveable support slide 124 operated by a hydraulic or pneumatic cylinder 123, or other suitable actuator, moves into the gap g to support a headliner core as it is conveyed into position at station 3 (16) (FIG. 10C). Thereafter, slide 124 can be retracted from gap g when a headliner core having a moon roof opening is properly positioned on the support features of station 3, so that it does not interfere with attachment of the moon roof backer ring to the headliner core (FIG. 10D).

In the embodiment shown, backer ring supports 120 and infrared heater attachment devices 56 are mounted on a platform 120a, which is raised and lowered by suitable cylinders, not shown. When a core 40 is in position, and slide 124 is retracted, platform 120a is raised, causing the backer ring to engage core 40. Heaters 56 are then activated to seal the backer ring to core 40.

Referring to FIG. 1, it will be noted that there is a space 17-18 between station 4 (17) and station 5 (18). A pair of power screwdrivers 88 are located at station 5. The space 17-18 allows a worker or workers to access drivers 88 and the headliner core which is being worked on at station 5.

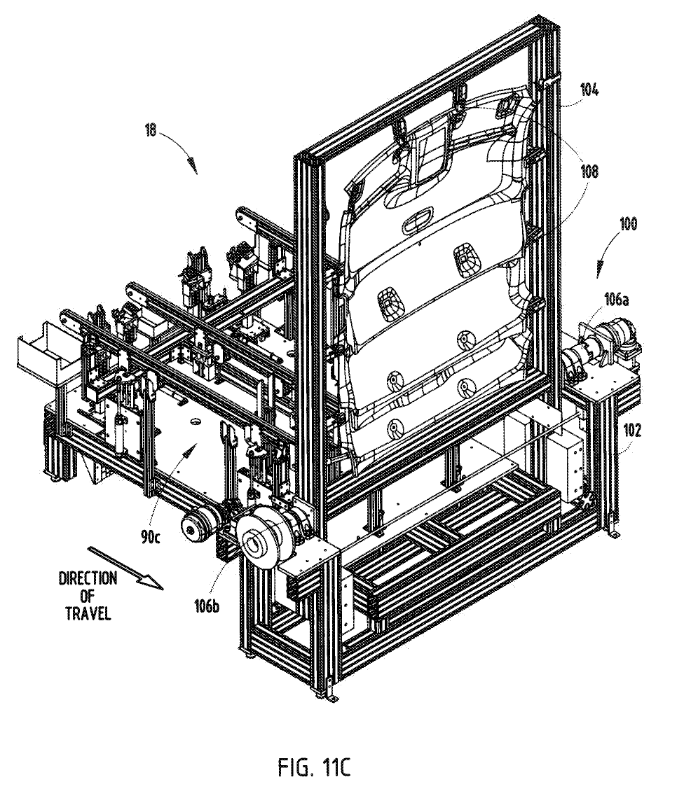

In order to make it possible to convey a headliner core from station 4 (17) to station 5 (18), another type of conveyor 90b is provided (FIG. 10E). Conveyor 90b is similar to conveyor 90, having correspondingly numbered parts labeled with the addition letter “b.” However, conveyor 90b differs from conveyor 90 and conveyor 90a in that it is not elevated and lowered by means of vertically oriented cylinders. Instead, the elevating mechanism is a parallelogram arrangement which is moved up and down by cylinder 100. Because station 4 is an accumulator station, conveyor 90b is basically the only mechanism located at station 4. When cylinder 100 is retracted as shown in FIG. 10E, the parallelogram legs 101 abut stops 101a, and conveyor 90b is ready to receive a headliner core 40 from station 3. As the core is advanced onto conveyor 90b, conveyor belts 91b, 92b and 93b are activated to advance the headliner core to a position where it is supported entirely by conveyor 90b. When station 5 is ready for another core, cylinder 100 extends until the legs 101 to which cylinder are attached come into abutment with downstream stops 101b. At that point, the ends of rails 97b, 98b, and 99b are extending out into the space 17-18 between stations 4 and 5. Conveyor belts 91b, 92b and 93b are then activated and the headliner core is advanced to station 5 (18). After the core has been received by conveyor 90c at station 5 (FIG. 11), cylinders 100 are retracted again until the legs 101 to which they are attached come into abutement with stop 101a again. A worker can then enter the space 17-18 between stations 4 and 5 and perform assembly operations, e.g., assembling visors to the headliner core, using drivers 88, for example. Conveyor 90c is basically the same as conveyor 90.

In the illustrated embodiment of apparatus 10, a headliner core proceeds from one station to the next station, and resides at each station, for assembly operations, with the interior side (i.e. the side that faces the cabin interior when installed in a vehicle) facing upwardly. However, it is convenient to change the orientation of the headliner core for certain assembly operations. For example attachment of wiring and wiring harnesses to the core at station 6 (19) is desirably performed with the interior side of the core facing downwardly, and the opposite, exterior side of the core facing upwardly. Accordingly, station 5 (18) includes a headliner invertor 104 (FIG. 11) having a base 102 on which invertor frame 104 is pivotally mounted. Frame 104 is pivotally mounted on base 102 for rotation around axles 106a and 106b. Spaced apart along the periphery of frame 104 are a plurality of clamps 108 for gripping edges of a headliner core and holding during rotation of frame by 180 degrees to flip the core over into an inverted position. As shown in FIGS. 11A and 11B, clamps 108 include opposing jaws 110 and 112 that are moveable between a closed or headliner core gripping position (FIG. 11A) and an open position (FIG. 11B). FIG. 11C shows a headliner core (partially attached) that is held on a frame 104, with frame 104 rotated into an upright position half way between visor assembly accumulator station 5 (18) and station 6 (19). In such position, headliner invertor 101 may be used as an accumulator between stations 5 and 6 to temporarily hold a partially assembled headliner while work on a preceding headliner is completed at stations 6 (19), and while freeing station 5 for assembly operations on a successive headliner, and/or to accumulate another headliner.

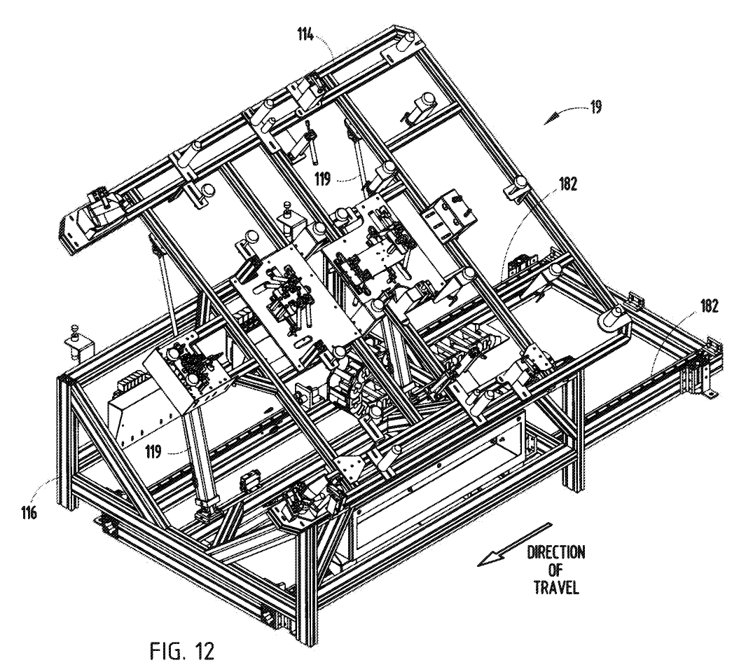

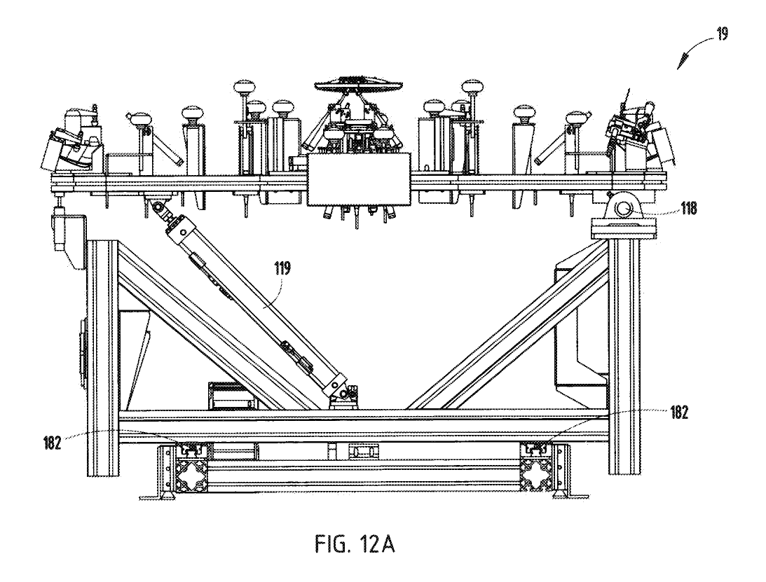

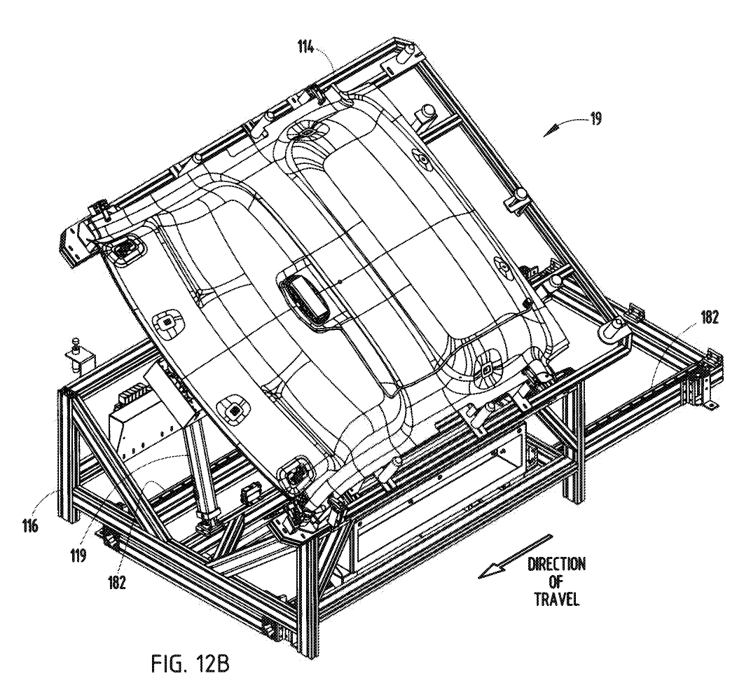

FIG. 12 shows station 6 (19) of apparatus 10 having a headliner support structure 114 that is pivotally mounted on a base 116 to allow rotation of structure 114 around an axis that is parallel to the direction of travel of a headliner core as it moves from one station to the next. Rotation of structure 114 allows workers easier access to the headliner core to facilitate certain assembly operations, such as manual installation of wires and wiring harnesses. As shown in FIG. 12A, structure 114 is rotatable around an axle or pivot 118. Rotation may be effected by one or more hydraulic or pneumatic cylinders 119, or other actuator, such as an electric motor. FIG. 12B shows support structure 114 rotated into its raised position, with a headliner core 40 in position thereon.

The entire base and support assembly (116-114) at station 6 (19) is moveable along track 182 from right to left (and back) as shown in FIG. 12, by means of a suitable driver device (a cylinder not visible in the figure). The assembly thus moves along track 182 between an assembly position as illustrated, and a position for receiving a partially assembled headliner from a preceding station. This allows human operators to access the headliner at the front of the station and at both opposite sides of the station.

A controller 65 (FIG. 1), such as a computer or microprocessor, is provided for controlling apparatus 10. Controller 65 may be used to at least ensure that each headliner core 40 has the required components fastened to it during the assembly process. This may be achieved by first proving a reader 68 (FIG. 2) that may be located at the loading station, as illustrated, or alternatively, at the first assembly station 14. Reader 68 may be a conventional bar code scanner or any other device capable of reading information from a tag, label or the like affixed to or applied to a core 40. Information on the tag, label or the like preferably includes a listing of all of the components that are to be affixed to the headliner core 40. Reader 68 is operably connected to controller 65 such that information read from a tag, label or the like affixed to or applied to a headliner core 40 by reader 68 is communicated to controller 65. Controller 65 employs this information to ensure that the appropriate components are loaded onto the appropriate parts nests. This may be achieved by alerting human or robotic operators which components or parts nests are to loaded, verifying that this has been achieved, and not proceeding until the appropriate parts nests have been properly loaded. Controller 65 may also operate applicators 56 and presses 58 when the appropriate components have been properly loaded in the parts nests. Desirably, controller 65 is operably connected to applicators 56, presses 58, and sensors 60 to activate applicators 56 and presses 58 to affix components to core 40 when the parts nests are properly loaded, and to prevent activation of applicators 56 and presses 58 when a required component is missing from a parts nest, or when a component is improperly loaded on a parts nests, either because it is not correctly positioned on the parts nest or because it should not be there at all.

Controller 65 includes, or is operably connected to, electronic memory for retaining data read by reader 68, and for maintaining a record for each headliner core and associated finished assembly. Such data may include the data received by reader 68 and at least one additional datum relating to the assembly process. Such additional datum or data may include information tending to verify that all of the required components have been properly affixed to the core, or indicating that one or more components may not have been properly affixed to the core. For example, one or more sensors may be associated with applicators 56 to collect data indicative of whether applicators 56 has functioned properly to secure a component to core 40. For example, the electrical current to an infrared heat applicator 56 may be measured and recorded as a function of time to determine whether an appropriate amount of energy has been employed to affix a component to core 40. A range of appropriate electrical current profiles as a function of time that provide a satisfactory result may be determined experimentally and used to predict whether a measured current profile was adequate to achieve satisfactory bonding of a component to the core. Such arrangement may function as an adherence sensor.

While it is conceivable that robotic systems may be employed to load components into the parts nests at the various assembly stations 14, 15, 16, 17, 18 and 19, human operators may also be employed to accomplish this task. In such case, it is necessary, or at least desirable, that the apparatus 10 include means for communicating to the human operators which component or parts nests need to be provided with the appropriate components. A relatively simple and effective means for achieving this communication is to have controller 65 operatively connected to indicators associated with each of the parts nests. For example, a light may be illuminated adjacent to or on each parts nests that is to be loaded with a component. In order to reduce the possibility of error and/or delay caused by a malfunctioning light, each parts nest may have two different lights or indicators associated with it, one to definitely indicate that a part is to be loaded onto the nest, and another one (e.g., a different color) to definitely indicate that a part is not to be loaded.

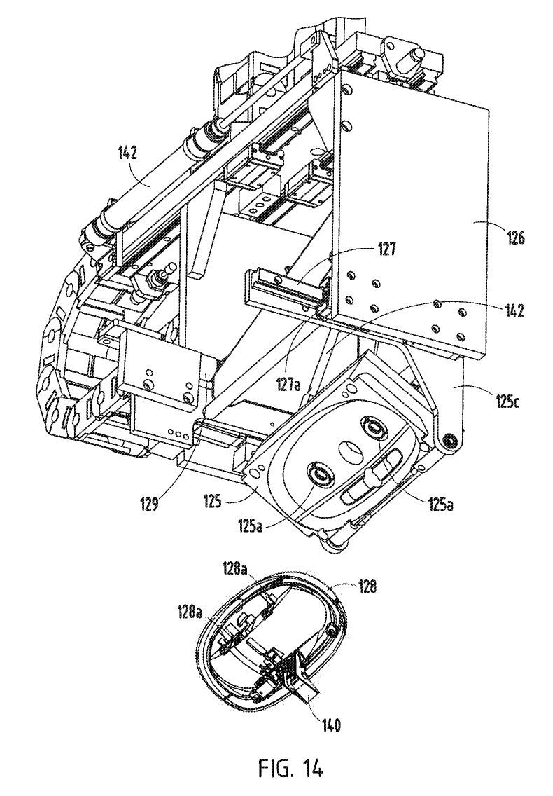

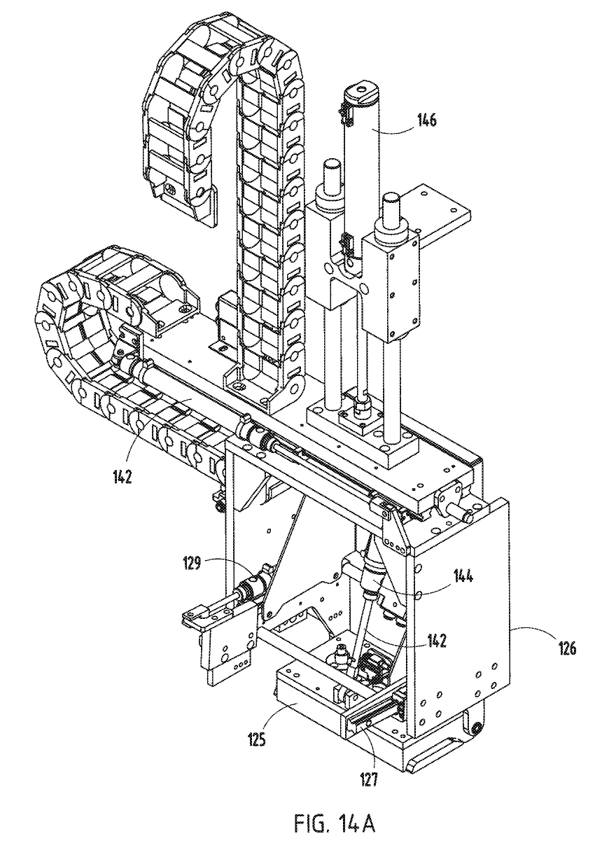

With the overall apparatus and controller system of the present invention thus described, we will now describe in greater detail exemplary parts nests which can be used in the apparatus of the preferred embodiment, as well as details of their operation. One of the assemblies performed at station 1 is the assembly of a lamp retainer 132 (FIG. 13) to core 40. Retainer 132 is shown exploded away from parts nest 43 in FIG. 13. Retainer 132 includes corner tabs 132a and 132b which project above the level of the perimeter of retainer 132, on the ends of flexible vertical or lateral arms. Retainer tabs 132c project above the perimeter of retainer 132 from the top of shorter, less flexible arms on the other side of retainer 132 from tabs 132a and 132b. A slot 133 is located near the top edge of one side of retainer 133, between tabs 132a and b. Spaced inwardly projecting tabs 133b are positioned on the opposite side of retainer 132. When a lamp 128 (FIG. 14) is assembled to retainer 132, a tab 140 on lamp 128 extends into slot 133, and a pair of keepers 128a on lamp 128 are snapped past retaining tabs 133b to hold lamp 128 and retainer 132 together.

Parts nest 43 is mounted on a mounting plate 43g which is part of a carrier assembly 134. When retainer 132 is seated in nest 43, pushers 43b (FIG. 13) are activated to push tabs 132a and 132b inwardly towards the opposite side of retainer 132. Pushers 43b are pivotably mounted in mounting blocks 43c mounted on plate 43g (FIG. 13a) and are pivoted by cylinders 43d located below mounting plate 43g. A spaced light beam projector and receiver combination 60 provides an indication to controller 65 that a retainer 132 is properly positioned within parts nest 43, since retainer 132 blocks the beam (60a in FIG. 13) passing between the beam projector and receiver pair 60. Parts nest 43 for lamp retainer 132 is mounted on a carriage assembly 134 so as to be moveable between a loading position and an assembly position. Carrier assembly 134 comprises an upper carrier comprising upper plates 43g and 43h, and a lower assembly comprising a lower plate 134b. Upper carriage assembly includes slides 43f which engage and slide on a pair of spaced tracks 43e. A small cylinder not shown causes plate 43h to slide to the right or left on slides 43f mounted on tracks 43e, as viewed in FIG. 13a. Lower plate 134b of carriage assembly 134 includes bearings 134a that ride along tracks 138 and 139. Movement of carriage 134 and parts nest 43 can be effected by a hydraulic or a pneumatic cylinder 136, or any other suitable actuator. Thus, carriage assembly 134 and parts nest 43 can be moved either to a loading position toward the outside edge of the assembly station, or can be moved into position beneath a core 40 which is awaiting installation of retainer 128.

In addition, a cylinder 135 raises and lowers carriage assembly 134. When nest 43 is moved towards the outside edge of the assembly station, cylinder 135 mounted on plate 134 b raises the upper carriage assembly in order to provide easy access for loading a retainer 128 into nest 43. When a core 40 is in place at the assembly station, nest 43 is lowered again, and carriage 134 is slid back along tracks 138 and 139 to a position below a retainer ring opening in the core. Controller 65 activates cylinder 135 again, which lifts carriage assembly 134, parts nest 43, and retainer 128 therein, up to and through the retainer receiving opening in core 40.

Once in position, a cylinder (not shown) slides plate 43h and the upper carriage assembly, including nest 43 and retainer 128 therein, to the right as shown in FIG. 13A, which causes retainer tabs 132 to catch on the upper surface of core 40, at the edge of the opening therein. Approximately simultaneously, pushers 43b are retracted, allowing retainer tabs 132a and 132b to flex back and to engage the upper surface of core 40 at the opening edge located opposite to the edge engaged by tabs 132c. Retainer 132 is then securely assembled to core 40 at an appropriate opening therein.

Parts nest 43 is thus moveable between a position that is easily accessible to an operator loading components into parts nests and a second position in which the nest is properly located for assembly of the part to the headliner core. Controller 65 may be programmed or otherwise configured to keep parts nest 43 out of, or away from, the proper assembly position if, based on information from reader 68, the headliner is not to include a component for which the parts nest is designed to receive.

At station 2, dome/map lamps 128 are assembled into lamp retainers 132 that have previously been secured to headliner core 40 as discussed above. As shown in FIGS. 14 and 14A, a dome/map lamp holder 125 is pivotally mounted on a bracket 125c, which in turn is slidably mounted on a press frame 126 by means of tracks 127 slidably carried in guides 127a mounted on press frame 126. A lamp 128 is held in nest 125 by means of a suction drawn through suction cups 125a (FIG. 14).

A cylinder 144 pivots nest 125 between a loading position and a final assembly position, while another cylinder 129 (FIG. 14A) slides bracket 125c, nest 125 and lamp 128 to the right as viewed in FIGS. 14 and 14A. Press frame 126 is moveable vertically by a hydraulic or pneumatic cylinder 146 (FIG. 14A), between a position above a headliner core located on support features of the assembly station, and an assembly position which places a dome/map lamp 128 located in holder 125 adjacent the headliner core. Tab 140 on lamp 128 is inserted into a tab receiver slot 133 in lamp retainer 132 by being simultaneously pivoted by cylinder 144, lowered by cylinder 146, and moved horizontally forward toward slot 133 by cylinder 129.

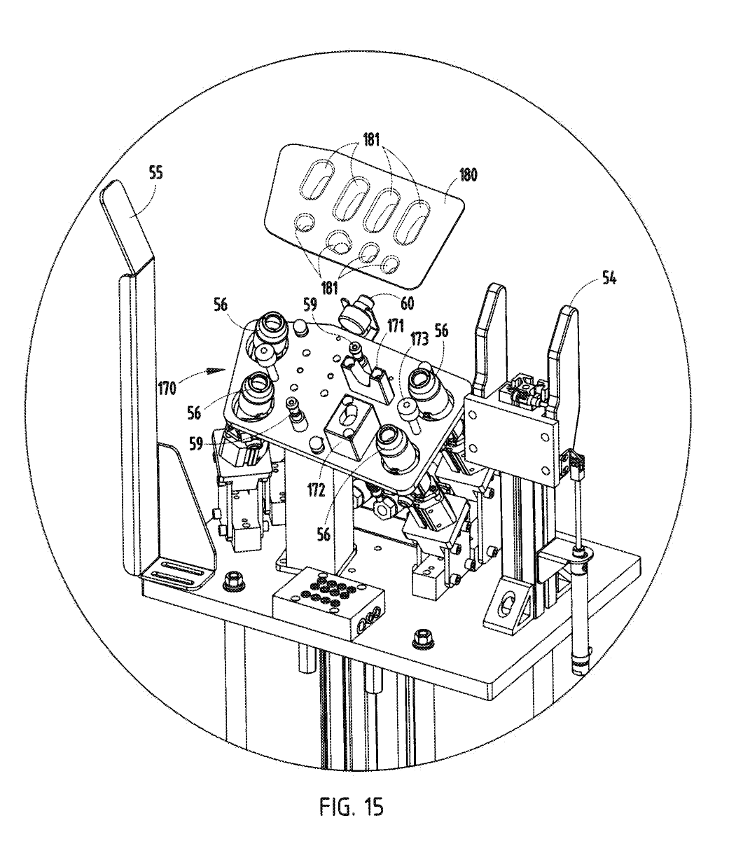

FIG. 15 shows an enlarged view of one of several parts nests 170 adapted for receiving safety countermeasures 180. Countermeasures 180 are formed polypropylene members having protrusions such as oblong protrusions 181 and finger shaped protrusions 181 formed therein to give them something of an “egg carton appearance. Nest 170 includes a “v” shaped plate for receiving a protrusion 181 therein, and a smaller block 172 with an opening therein for receiving a finger shaped protrusion 182 therein. Part 180 also engages a urethane bumper 173, and an indicator 60 indicates that part 180 is in position in parts nest 170. Vacuum cups 59 help hold part 180 in place in nest 170. When the controller 65 is informed that part 180 is to be placed in nest 170, the vacuum to cups 59 is turned on. When proximity part sensor 60 indicates that part 180 is in position, a vacuum sensor indicates whether a good vacuum seal exists between part 180 and vacuum cups 59. If it does not, the controller stops the operation. Thus, vacuum cups 59 also act as parts sensors to insure that the part is properly located. Infrared heaters 56 not only facilitate attachment of the countermeasure 180 to a core 40, but also serve to form the nest for receiving countermeasure 180. Appropriate safety countermeasures are placed in the parts nests and held against the core as they are attached, preferably by infrared heat welding with welders 56. As can be seen in FIG. 5, nests 170 move on tracks 170a in response to cylinder 170b, to accommodate different sized headliner cores 40.

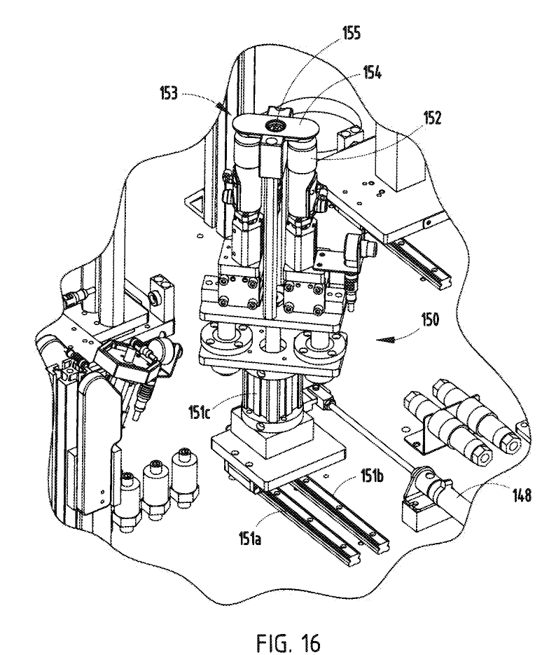

FIG. 16 illustrates a parts nest assembly 150 including a parts nest 152 for holding a magnet assembly 153 in position for assembly to a headliner core. Magnet assembly 153 comprises a polypropylene case or carrier 154 having an opening into which a magnet 155 is inserted. Parts nests assembly 150 is slidably mounted on tracks 151a and 151b, and can be moved along the tracks by operation of an actuator 148 (e.g., pneumatic or hydraulic).

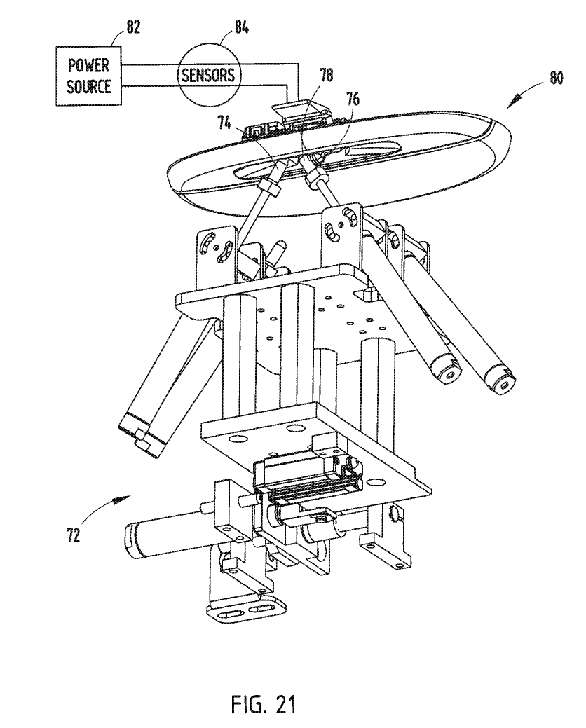

At the left end of tracks 151a and 151b as shown in FIG. 21, parts nest 152 is elevated slightly by cylinder 151c to raise the magnet assembly 153 to the proper level for adherence to the headliner core. Once the assembly is completed, cylinder 115c retracts downwardly and cylinder 148 draws parts nest assembly 150 back to the right as shown in FIG. 21. A new magnet assembly 153 can then be loaded into parts nest 152 and the lateral and upward movement repeated to assemble yet another magnet assembly to a headliner core.

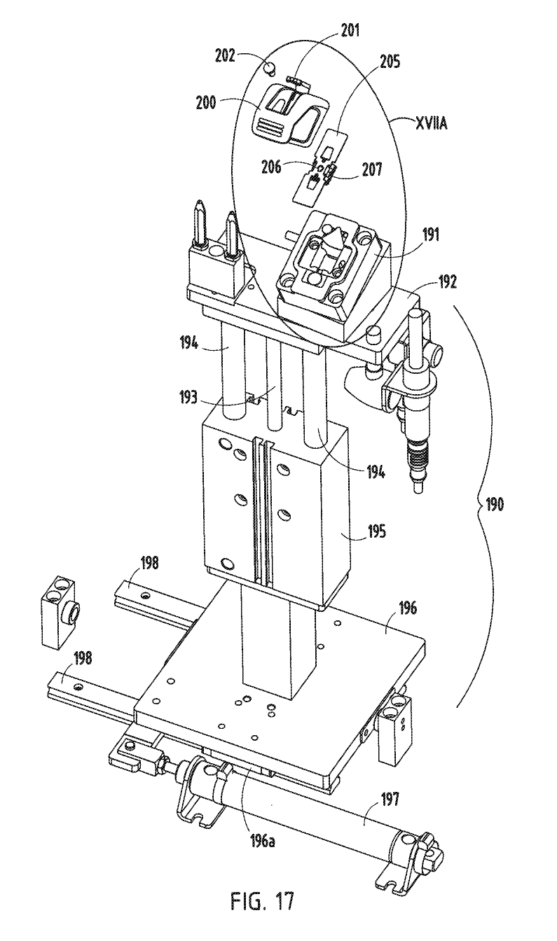

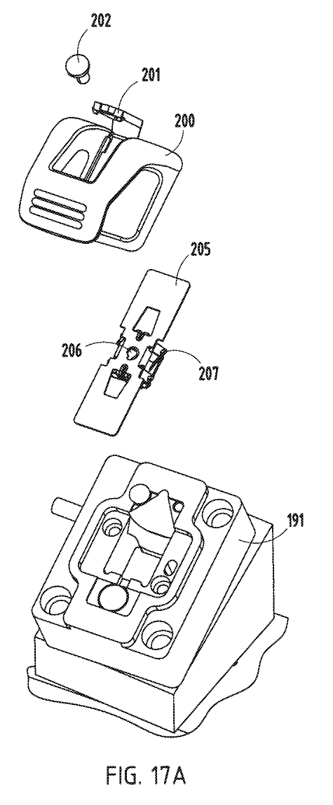

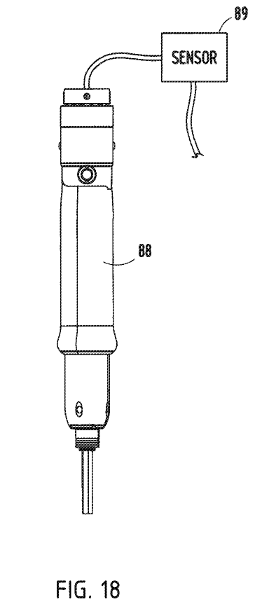

Station 3 (16 in FIG. 10B) includes one or more screw drivers 88 which are used to attach coat hooks to a coat hook clip 205 located in parts nests 191 at station 3, by threading screw 202 into hole 206 in clip 205 (FIGS. 17 and 17A). Clip 200 is located on the backside of core 40, and the coat hooks 200 are positioned on the front side of core 40. Screw drivers 88, as used here and elsewhere in the apparatus, have sensors 89 that measure torque (FIG. 18), time and number of revolutions of the screw driver. The sensors are operatively connected to controller 65, which compares the measured torque, time and number of revolutions to a register containing data on the correct or allowable range of torque, time and revolutions that constitute an acceptable assembly. Unacceptable assemblies may be tagged for recycling, repair or reprocessing as appropriate. Similar drivers are used to assemble other components, as for example the visors.

Parts nest 191 is part of a parts nest assembly 190 which facilitates movement of parts nest 191 between a part loading position and a part installing position. Nest 191 is mounted on a platform 192 which can be raised and lowered by means of a cylinder 193 (rod only shown) and stabilizing rods 194, carried in a stabilizer block 195. Block 195 is in turn mounted on a platform 196, which includes slides 196a mounted on tracks 198. Plate 196 can then be shifted back and forth on tracks 198 by means of cylinder 197. To load a clip 205 into nest 191, cylinder 193 lowers platform 192 and nest 191, and cylinder 197 then shifts platform 196 to the nest loading position. Nest 191 may again be elevated by cylinder 193 at the parts loading position. At the loading position, a clip 205 is located in nest 191. Nest 191 includes a magnet, and clip 205 is made of a ferromagnetic material, such that the magnet firmly holds clip 205 in position within nest 191.

Nest 191 is then moved to its assembly position by reversing the foregoing steps. Cylinder 193 lowers nest 191, cylinder 197 slides platform 196 over until nest 191 is properly located below the intended opening in core 40. Cylinder 193 then elevates nest 191 until parts nest 191 and clip 205 are in engagement with core 40. Driver 88 (FIG. 18) is the used to drive screw 203 into a receiving aperture 206 in clip 205.

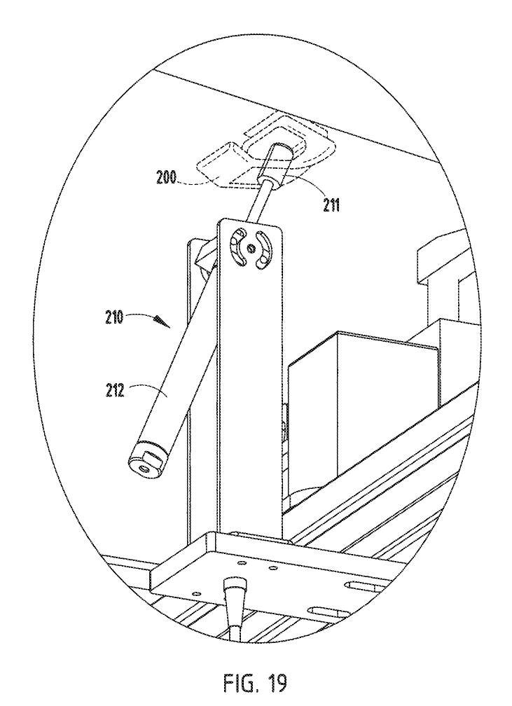

Coat hook 200 includes a hinged flange 201 which is open during installation of coat hook 200 into clip 205. However, once screw 203 is in place, it is covered by closing hinged cover 201 over the top of screw 203. FIG. 19 shows a parts cover closer 210, used for closing covers such as cover 201 on coat hook 200. Cover closer 210 includes a finger 211 that is reciprocally moveable by an actuator 212 (e.g., hydraulic or pneumatic). Finger 211 is engagable with hinged closeable cover 201 on coat hook 200. The screw 203 or other fastener is thus concealed by the closed cover 201.

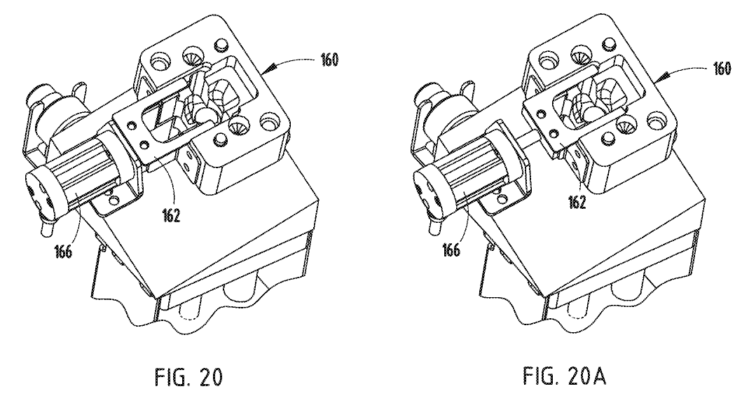

As shown in FIGS. 20 and 20A parts nest 160 has a lock 162 that slides into and out of a holding position (as shown in FIGS. 20A and 20, respectively). Lock 162 holds a “cowboy hat” bracket in place within the parts nest 160. Such brackets serve as spacers or standoffs to space the top of the headliner core from the metal roof of the vehicle to which the headliner/overhead system assembly is to be secured.

Station 6 (19) includes a dome/map lamp toggle 72, which is shown in FIG. 21. Toggle 72 comprises robotic fingers 74 and 76 for engaging and operating a toggle switch 78 of a dome/map lamp 132. A power source 82 is provided at station 6 (19) for temporarily powering dome/map lamp 132 for testing. Fingers 74 and 76 are moveable to turn dome/map lamp 132 on and off to test that it is operating properly after installation. Fingers 74 may be operated hydraulically or pneumatically and controlled by controller 65.

The power source 82 used for powering dome/map lamp 132 during testing may include electrical load sensors 84, such as an electrical current sensor, mechanical resistance sensor, or the like for measuring the electrical performance of the dome/map lamp during operation to ensure that it is operating within predetermined acceptable parameters. This information is then supplied to controller 65, to confirm that the map/dome lamp 132 is operating properly, or not.

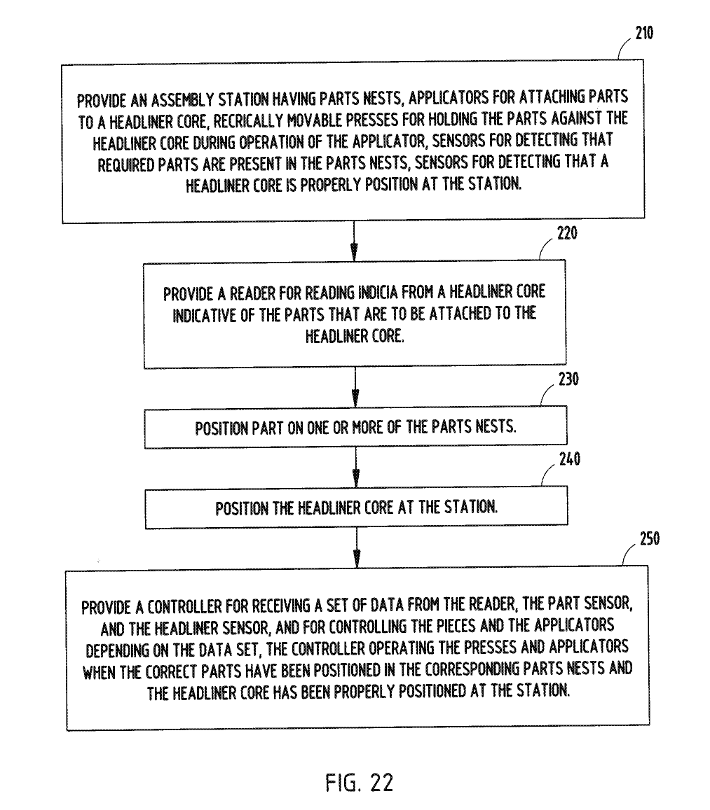

A process in accordance with the invention is illustrated schematically in FIG. 22. The process generally involves a first step 210 of providing an assembly station having one or more parts nests, one or more applicators for attaching parts to a headliner core, one or more reciprocally moveable presses for holding the parts against the headliner core during operation of the applicator to attach the parts to the headliner core, one or more sensors for detecting that the required parts are present in the parts nests, and one or more sensors for detecting that a headliner core has been properly positioned at the assembly station.

In a second step 220 of the process, a reader is provided for reading indicia from a headliner core, wherein the indicia is indicative of the parts that are to be attached to the headliner core. The indicia may also include information regarding the identity, characteristics and/or dimensions of the headliner, when the process apparatus is used for assembling headliners having different headliner cores. The indicia may be printed directly on the headliner, but will more typically be printed on a sticker or the like attached to the headliner core. In a third step 230, the parts required for the particular headliner as indicated by the data read from the reader are positioned on the parts nests. Thereafter, in step 240, a headliner core is positioned at the station in a proper orientation so that the parts can be attached to the headliner core at the appropriate locations. In step 250, a controller is provided for receiving a set of data from the reader, the parts sensor and the headliner sensor, and for controlling the presses and the applicators depending on the data set. The controller operates the presses and applicators when the correct parts have been positioned in corresponding parts nests and the headliner core has been properly positioned at the station. Preferably, core sensors operably connected to controller 65 identify whether a core is properly located based on the distance of the core from the sensor. The controller responds to information from the reader to establish the distance the core sensor should be from the core.

The digital memory associated with controller 65 retains data on whether or not an assembly operation performed by the apparatus on a given headliner was properly performed, as indicated by sensors that are operatively connected to said controller. A final reader operatively connected to controller 65 reads the indicia on a finished headliner core and an indicator operatively associated with the retained data is activated when said indicia on said headliner core is read by said final reader, to indicate whether or not all assembly operations were properly performed.

Various sensors are operably connected to the controller to provide the data necessary to confirm that an operation has been successfully completed. For example, adherence sensors associated with applicators are operatively connected to controller 65 to sense that proper adherence is obtained. Preferably, adherence sensors measure the power used and time spent by said heat welders during a cycle, as a measure of whether or not proper adherence has been attained.

An electrical sensor associated with the lamp power source is operatively connected to controller 65 to measure amperage and/or resistance to determine that the dome/map lamp is operating correctly. Sensors associated with screwdrivers used in the process measure torque, time and revolutions of said screw driver; are operatively connected to controller 65, for comparing measured torque, time and revolution information to a range of acceptable torques, times, and revolutions.

The above description is considered that of the preferred embodiment(s) only. Modifications of the invention will occur to those skilled in the art and to those who make or use the invention. Therefore, it is understood that the embodiment(s) shown in the drawings and described above are merely for illustrative purposes and not intended to limit the scope of the invention, which is defined by the following claims as interpreted according to the principles of patent law, including the doctrine of equivalents.

The invention claimed is:

1. An apparatus for assembling vehicle headliner/overhead systems comprising:
a loading station having a load support configured to receive and hold a preformed three dimensionally configured headliner/overhead system core;
at least one assembly station; each assembly station including a core support configured to receive and hold said preformed headliner/overhead system core, and each of said core supports including one or more parts nests configured to hold and position an overhead system component adjacent said preformed headliner/overhead system core;
at least one of said parts nests including at least one associated applicator to facilitate assembly of an overhead system component to said preformed headliner/overhead system core;
each of said assembly stations including a press, each said press configured to hold said headliner/overhead system core in position on said core support and to press said headliner/overhead system against any component located in any of said component parts nests;
one of said press and said support being reciprocally moveable with respect to the other, whereby said press comes into and out of engagement with said preformed headliner/overhead system core;
at least one of said core supports including a core sensor associated therewith to sense whether or not a headliner/overhead system core is properly positioned on said core support;
at least one of said parts nests including at least one parts sensor associated therewith to sense whether or not an overhead system component is positioned in said parts nest;
a controller for controlling said apparatus;
a reader located at one of said loading station or the first of said at least one assembly station for reading indicia on said headliner/overhead system core which indicate what overhead system component need to be assembled to said headliner/overhead system core, said reader being operatively connected to said controller, such that the information read is communicated to said controller;
said core sensor associated with said core support and said parts sensor associated with said parts nest being operatively connected to said controller for communicating to said controller whether said headliner/overhead system core is properly positioned on said core support and appropriate ones of said components are properly positioned in appropriate parts nests;
said controller being operatively connected to said applicators and to said moveable one of said core support and said press at each said assembly station, said controller activating said moveable member and any applicator or applicators which are supposed to be activated, as indicated by the information read into said controller by said reader; and
said controller being programmed not to activate said moveable member and said applicators if any of said headliner/overhead system core and said overhead system component are not in place and properly positioned, or if an overhead system component is positioned in a parts nest when it is not supposed to be there.

2. The apparatus of claim 1, which includes an electronic memory associated with said controller, which retains data on whether or not an assembly operation performed by the apparatus on a given headliner/overhead system was properly performed, as indicated by sensors that are operatively connected to said controller.

3. The apparatus of claim 1, further comprising:
a final reader operatively connected to said controller, which can be used to read the indicia on said headliner/overhead system core after the headliner/overhead system is assembled; and
an indicator operatively associated with said data base which is activated when said indicia on said headliner/overhead system core is read by said final reader, to indicate whether or not all assembly operations were properly performed.

4. The apparatus of claim 1, in which each of said parts nests includes an indicator operatively connected to said controller, which indicates whether or not a part should be loaded into the parts nest based on the information communicated to the controller by said reader.

5. The apparatus of claim 1, which includes an adherence sensor associated with said applicators, said adherence sensor operatively connected to said controller to sense that proper adherence is obtained.

6. The apparatus of claim 1, which includes a station having a dome/map lamp power source, and fingers for activating a dome/map lamp assembled to said core, to turn the dome/map lamp on and off for testing.

7. The apparatus of claim 6, which includes an electrical sensor associated with said lamp power source, said electrical sensor operat ively connected to said controller to measure amperage and/or resistance to determine that the dome/map lamp is operating correctly.

8. The apparatus of claim 1, in which said core sensor identifies whether a core is properly located based on a distance of the core from the sensor; said controller responding to information from said reader to establish the distance the core sensor should be from the core.

9. The apparatus of claim 1, in which at least one of said assembly stations also includes a screw driver having a sensor associated therewith for measuring torque, time and revolutions of said screw driver; said screw driver sensor being operatively connected to said controller, which compares said measured torque, time and revolution information to a range of acceptable torques, times, and revolutions.

10. The apparatus of claim 1, in which said applicators are infrared welders, and said adherence sensor measures the power used and time spent by said welders during a cycle, as a measure of whether or not proper adherence has been attained.

11. The apparatus of claim 1, in which at least one of said assembly stations includes a conveyor for conveying said headliner/overhead system core into and out of said station;
one of said conveyor and said headliner/overhead system support being moveable up and down relative to the other, whereby the conveyor can be located above the level of said support or located below the level of said support;
said conveyor being operable, when it is in position above the level of said support, to convey a headliner/overhead system core into position above said support;
the moveable one of said conveyor and said support being operable to position said conveyor below the level of said support and thereby place said headliner/overhead system core onto said support; and
said moveable member then being operable to position said conveyor above the level of said support to thereby lift said headliner/overhead system off of said support after assembly operations at said assembly station have been completed, and then being operable to convey said headliner/overhead system core and assembled headliner/overhead system components to the succeeding assembly station, if there is one.

12. The apparatus of claim 11, in which said conveyor comprises pair of spaced side conveyors which support and convey said core near its side edges, and an intermediately located conveyor which supports and conveys said core in the area between said side conveyors; said intermediately located conveyor being adjustable up and down relative to said side conveyors, at the direction of said controller, based on information received by said controller from said reader, to accommodate headliner/overhead system cores of differing depths.

13. The apparatus of claim 12, which includes a plurality of said assembly stations.

14. The apparatus of claim 13, in which said apparatus includes one accumulator station for accumulating at least one headliner/overhead system core in the event assembly operations at a succeeding station or stations are not yet completed.

15. The apparatus of claim 14 with a support at an assembly station or at said accumulator station being pivotally mounted at one end on an axis extending laterally of the direction of travel of a headliner/overhead system core into the station, and including clamps moveable into and out of engagement with said headliner/overhead system core to clamp it in place on said support and release it, respectively;
said pivotally mounted support being operable to rotate about said pivot axis from a position within said station, to a position within the next adjacent station, whereby said headliner/overhead system core is placed on the support in the next adjacent station in an inverted position.

16. The apparatus of claim 15, in which said load support at said loading station is pivotally mounted for movement between a generally upright position to a generally horizontal position, whereby said headliner/overhead system core can be loaded into said load support when it is in its generally upright position, and then the load support and associated panel can be pivoted to said general horizontal position to facilitate conveyance of said headliner/overhead system core to the first assembly station.

17. The apparatus of claim 16 with the support at least one assembly station being pivotally mounted about an axis generally parallel to the direction of travel of an headliner/overhead system core into the assembly station, for movement from a generally horizontal position to an inclined position, whereby assembly workers have easier access to the headliner/overhead system core on the support to facilitate manual assembly procedures.

18. The apparatus of claim 11, in which at least one of said assembly stations includes supports for holding a backer ring for a moon roof opening;
said conveyor including one of an intermediately located support or conveyor located between the side edges of said core, and in the path of said moon roof opening as a core is conveyed into said assembly station;
said intermediately located support or conveyor having a gap in its length which is greater than the width of said moon roof opening, whereby said backer ring can be moved up into engagement with said core without interference from said generally centrally located support or conveyor; and
said support including a moveably mounted support slide which slides into said gap to support said core as it is conveyed into position on said support, said slide then retracting from said gap when said core is in position on said support, so that it does not interfere with the movement of said backer ring parts nest as it moves up into and out of proximity to said core.

19. The apparatus of claim 1, in which there is at least one of said parts nests also located on said press.

20. The apparatus of claim 1, in which each of said core supports includes core guides to guide the core into its proper position on said core support.

21. The apparatus of claim 1, in which at least one of said parts nests on at least one of said core supports does not have an associated applicator.

22. The apparatus of claim 1 including a press carrier carrying a plurality of presses in which the press carrier is moveable toward a core on said core support, and the plurality of presses individually moveably mounted on said press carrier are moveable into engagement with said core at said parts nests.

23. The apparatus of claim 1, in which at least one of said parts nests is moveable to and from a loading position, which is more convenient for loading parts, and to and from an assembly position in which it is properly located for assembly of a part to said headliner/overhead system core.

24. The apparatus of claim 23, in which said parts nest loading position is out of the way of said core when it is being placed on and is in position on said core support, whereby parts can be loaded into said parts nest while said core is being positioned and/or while other assembly operations are being conducted.

25. The apparatus of claim 23, in which said moveable parts nest is moveable on a track.

26. The apparatus of claim 1, in which at least one of said parts nests is moveable to and from an assembly position in which it is properly located for assembly of a part to said headliner/overhead system core; said controller keeping said parts nest out of said assembly position if based on information from said reader, the headliner/overhead system to be assembled is not to have the part which said parts nest is designed to receive.

27. The apparatus of claim 1, in which a dome/map lamp holder is moveably mounted on said press, and is moveable between a position above a headliner/overhead system core located on said support, and an assembly position which places a dome/map lamp located in said holder immediately adjacent said core;
said dome/map lamp holder being pivotable between its final position when it is assembled to said headliner/overhead system core, and a tab inserting position in which a light to be mounted on the headliner/overhead system core is oriented at an angle to said final position;
said controller acting to move said light holder into its assembly position, such that a tab on said light is moved into engagement with a tab retainer on said headliner/overhead system core; and
said controller then pivoting said light holder into said final position for final assembly to said headliner/overhead system core.

28. The apparatus of claim 27, in which said lamp holder includes suction members which hold a lamp in place in said lamp holder until it is pivoted into its final position, at which time said vacuum holders release said lamp.

29. The apparatus of claim 1, in which at least one of said parts nests is magnetic, for holding ferromagnetic metal parts in position for assembly to said headliner/overhead system core.

30. The apparatus of claim 1, in which at least one of said nests includes a parts lock which slides into and out of a holding position in which it holds a part in place within said parts nest.

31. The apparatus of claim 1 includes at least one or more moveable fingers controlled by said controller to close a cover of a part affixed to the core.

32. The apparatus of claim 1, in which at least one assembly station is mounted on a shuttle for moving closer to a preceding station or said loading station for receiving said core, and moves farther away for assembly of parts to said core.

33. The apparatus of claim 1 which includes a parts nest assembly for a lamp retainer to be attached to a core, wherein the retainer includes one or more first tabs on one side which project above the level of the perimeter of the retainer on the ends of flexible vertical or lateral arms, and one or more second tabs projecting above the perimeter of the retainer on the other side of the retainer, said parts nest assembly comprising:
a nest for the lamp retainer mounted on a carrier assembly;
pushers in said nest which can be activated to push said first tabs inwardly towards the opposite side of said retainer;
said carriage assembly comprises an upper carrier comprising a slidably mounted upper carriage and a lower platform, said upper carriage being supported on said lower platform by an elevator for raising and lowering said upper carriage;
whereby when a headliner core is in place at the assembly station, said elevator lifts said carriage up to and through a retainer receiving opening in said core, and said upper carriage is slidably shifted to cause said second retainer tabs to catch on the upper surface of said core, at the edge of the opening therein, and said pushers are retracted, allowing said first retainer tabs to flex back and to engage the upper surface of said core at the opening edge located opposite to the edge engaged by said second tabs.

34. The apparatus of claim 33 in which said lower platform comprises a slidably mounted lower carriage, whereby said retainer nest can be lowered, and lower carriage can be slid back and forth between a parts loading position, and a parts assembly position.

35. The apparatus of claim 1 in which parts are loaded into said parts nests robotically.

36. An apparatus for assembling vehicle headliner/overhead systems comprising:
a loading station having a load support configured to receive and hold a preformed three dimensionally configured headliner/overhead system core;
at least one assembly station; at least one assembly station including a core support configured to receive and hold said preformed headliner/overhead system core, and each of said core supports including one or more parts nests configured to hold and position an overhead system component adjacent said preformed headliner/overhead system core;
at least some of said parts nests including associated applicators to facilitate adherence of an overhead system component to said preformed headliner/overhead system core;
at least one of said assembly stations including a press, each press configured to hold said headliner/overhead system core in position on said core support and to press said headliner/overhead system against any component located in any of said component parts nests;
one of said press and said support being reciprocally moveable with respect to the other, whereby said press comes into and out of engagement with said preformed headliner/overhead system core;
said at least one assembly station including a conveyor for conveying said headliner/overhead system core into and out of said station;
one of said conveyor and said headliner/overhead system support being moveable up and down relative to the other, whereby the conveyor can be located above the level of said support or located below the level of said support;
said conveyor being operable, when it is in position above the level of said support, to convey a headliner/overhead system core into position above said support;
the moveable one of said conveyor and said support being operable to position said conveyor below the level of said support and thereby place said headliner/overhead system core onto said support; and
said moveable member then being operable to position said conveyor above the level of said support to thereby lift said headliner/overhead system off of said support after assembly operations at said assembly station have been completed, and then being operable to convey said headliner/overhead system core and assembled overhead system components to the succeeding assembly station, if there is one.

37. The apparatus of claim 36, in which said conveyor comprises pair of spaced side conveyors which support and convey said core near its side edges, and an intermediately located conveyor which supports and conveys said core in the area between said side conveyors; said intermediately located conveyor being adjustable up and down relative to said side conveyors, at the direction of said controller, based on information received by said controller from said reader, to accommodate headliner/overhead system cores of differing depths.

38. The apparatus of claim 36, in which at least one of said assembly stations includes a backer ring parts nest for holding a backer ring for a moon roof opening;
said backer ring parts nest being moveable from a position spaced below a headliner/overhead system core positioned on said core support, and a position which places the backer ring in proximity to the moon roof opening;
said conveyor including one of an intermediately located support or conveyor located between the side edges of said core, and in the path of said moon roof opening as a core is conveyed into said assembly station;
said intermediately located support or conveyor having a gap in its length which is greater than the width of said moon roof opening, whereby said backer ring can be moved up into engagement with said core without interference from said generally centrally located support or conveyor; and
said support including a moveably mounted support slide which slides into said gap to support said core as it is conveyed into position on said support, said slide then retracting from said gap when said core is in position on said support, so that it does not interfere with the movement of said backer ring parts nest as it moves up into and out of proximity to said core.

39. An apparatus for assembling vehicle headliner/overhead systems comprising:
at least one assembly station;
said assembly station including a core support configured to receive and hold a preformed headliner/overhead system core;
each of said assembly stations including a press, each said press configured to hold said headliner/overhead system core in position on said core support;
a controller for controlling said apparatus;
a parts nest for receiving a lamp retainer having a tab receiver, said lamp receiving parts nest being positioned on at least one of said core supports;
an applicator mounted adjacent said parts nest for securing said lamp retainer to said core;
a dome/map lamp receiving parts nest being moveably mounted on at least one said press, and being moveable between a position above a headliner/overhead system core located on said support, and an assembly position which places a lamp located in said holder immediately adjacent said core;
said lamp holder being pivotal between its final position when it is assembled to a lamp retainer secured to said headliner/overhead system core, and a tab inserting position in which a light to be mounted on the headliner/overhead system core is oriented at an angle to said final position;
said controller acting to move said lamp holder into its assembly position, such that a tab on said lamp is moved into engagement with a tab receiver in said lamp retainer on said headliner/overhead system core; and
said controller then pivoting said light holder into said final position for final assembly to said headliner/overhead system core.

40. The apparatus of claim 39, in which said lamp receiving parts nest includes a lamp lock which slides into and out of a holding position in which it holds a lamp in place in said lamp receiving parts nest, until it is pivoted into its final position, at which time said lock slides out of its holding position.

41. An apparatus for assembling vehicle headliner/overhead systems comprising:
at least one assembly station;
each assembly station including a core support configured to receive and hold said preformed headliner/overhead system core, and each of said core supports including one or more parts nests configured to hold and position an overhead system component adjacent said preformed headliner/overhead system core;
said assembly stations including a press, each said press configured to hold said headliner/overhead system core in position on said core support and to press said headliner/overhead system against any component located in any of said component parts nests;
one of said press and said support being reciprocally moveable with respect to the other, whereby said press comes into and out of engagement with said preformed headliner/overhead system core; and
a controller for controlling said apparatus.

42. An apparatus for assembling vehicle headliner/overhead systems comprising:
at least one assembly station;
each assembly station including a core support configured to receive and hold said preformed headliner/overhead system core, and each of said core supports including one or more parts nests configured to hold and position an overhead system component adjacent said preformed headliner/overhead system core;
each of said assembly stations including a press, each said press configured to hold said headliner/overhead system core in position on said core support and to press said headliner/overhead system against any component located in any of said component parts nests; and
one of said press and said support being reciprocally moveable with respect to the other, whereby said press comes into and out of engagement with said preformed headliner/overhead system core.

43. A method for assembling vehicle headliner/overhead systems comprising:
providing a loading station having a load support configured to receive and hold a preformed three dimensionally configured headliner/overhead system core;
providing at least one assembly station;
providing each assembly station with a core support configured to receive and hold said preformed headliner/overhead system core, and providing each of said core supports with one or more parts nests configured to hold and position an overhead system component adjacent said preformed headliner/overhead system core;
providing at least one of said parts nests with at least one associated applicator to facilitate assembly of an overhead system component to said preformed headliner/overhead system core;
providing each of said assembly stations with a press, each said press configured to hold said headliner/overhead system core in position on said core support and to press said headliner/overhead system against any component located in any of said component parts nests;
making one of said press and said support reciprocally moveable with respect to the other, whereby said press comes into and out of engagement with said preformed headliner/overhead system core;
providing each of said core supports with at least one core sensor associated therewith to sense whether or not a headliner/overhead system core is properly positioned on said core support;
providing each of said parts nests with at least one parts sensor associated therewith to sense whether or not an overhead system component is properly positioned in said parts nest;
providing a controller for controlling said press and the applicator;
locating a reader at one of said loading station or the first of said at least one assembly station for reading indicia on said headliner/overhead system core which indicate what overhead system components need to be assembled to said headliner/overhead system core, operatively connecting said reader to said controller, such that the information read is communicated to said controller;
operatively connecting said core sensors associated with said core supports and said parts sensors associated with said parts nests to said controller for communicating to said controller whether said headliner/overhead system core is properly positioned on said core support and appropriate ones of said components are properly positioned in appropriate parts nests;
operatively connecting said controller to said applicators and to said moveable one of said core support and said press at each said assembly station, said controller activating said moveable member and any applicator which is to be activated, as indicated by the information read into said controller by said reader; and
programming said controller to not activate said moveable member or said applicator if any of said headliner/overhead system core and said overhead system components are not in place and properly positioned, or if an overhead system component is positioned in a parts nest when it is not supposed to be there.
